(19) United States
(12) Patent Application Publication
(10) Pub. No.: US 2016/0080327 A1
(43) Pub. Date: Mar. 17, 2016

(54) TERMINAL APPARATUS, GATEWAY APPARATUS, AND RELAY APPARATUS CONNECTED TO CONTENT-CENTRIC NETWORK, AND COMMUNICATION METHOD

(71) Applicant: Panasonic Intellectual Property Corporation of America, Torrance, CA (US)

(72) Inventors: TAKAHIRO YONEDA, Osaka (JP); EIICHI MURAMOTO, Kanagawa (JP); RYOTA OHNISHI, Osaka (JP)

(21) Appl. No.: 14/845,956

(22) Filed: Sep. 4, 2015

(30) Foreign Application Priority Data
Sep. 12, 2014 (JP) 2014-186610

(51) Int. Cl. H04L 29/06; G06F 21/60

(52) U.S. Cl. CPC H04L 63/0428; G06F 21/606; H04L 63/0442

(57) ABSTRACT

A terminal apparatus is connected to a content-centric network and includes: a processor; and a non-transitory memory having stored therein instructions which, when executed by the processor, cause the processor to perform operations including encrypting a name of content data with a predetermined encryption key to convert the content data name into a first character string and generating a request packet in which a character string including a second character string indicating a name of a gateway apparatus and the first character string is stated as the content data name, and sending the generated request packet to the network.

### BACKGROUND

1. Technical Field

The present disclosure relates to a terminal apparatus, a gateway apparatus, and a relay apparatus connected to a content-centric network and a communication method for the apparatuses.

2. Description of the Related Art

In recent years, a next-generation network architecture has been proposed that allows content data to be obtained by specifying the name of content data itself, not the location of the content data.

For example, content-centric networking (CCN) technologies for the next-generation network architecture have been proposed, for example, in Patent Document 1 (U.S. Pat. No. 8,386,622) and Non-Patent Document 1 (Van Jacobson, Diana K. Smetters, James D. Thornton, Michael F. Plassi, Nicholas H. Briggs, and Rebecca L. Braynard. Networking Named Content. ACM CoNEXT, 2009).

In CCN, in order to obtain content data, a user's terminal apparatus sends out a request packet specifying the name of content data itself, not the location of the content data, to a network. Upon receiving the request packet, a content providing apparatus, which provides content, sends out a data packet of the content data corresponding to the name specified by the request packet.

However, Patent Document 1 and Non-Patent Document 1 mentioned above propose only a request packet and a data packet in which the name of content data is stated in plaintext and thus have a problem in that the confidentiality of communication for terminal apparatuses has not been considered.

### SUMMARY

One non-limiting and exemplary embodiment provides a terminal apparatus, a gateway apparatus, and a relay apparatus that can use a request packet considering the confidentiality of communication and a communication method for the apparatuses.

In one general aspect, the techniques disclosed here feature a terminal apparatus connected to a content-centric network. The terminal apparatus includes: a processor; and a non-transitory memory having stored therein instructions which, when executed by the processor, cause the processor to perform operations including encrypting a name of content data with a predetermined encryption key to convert the content data name into a first character string and generating a request packet in which a character string including a second character string indicating a name of a gateway apparatus and the first character string is stated as the content data name, and sending the generated request packet to the network.

According to the present disclosure, it is possible to realize a terminal apparatus, a gateway apparatus, and a relay apparatus that can use a request packet considering the confidentiality of communication and a communication method for the apparatuses.

It should be noted that general or specific embodiments may be implemented as a system, a method, an integrated circuit, a computer program, a storage medium, such as a compact disc read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating one example of the configuration of a content delivery system according to a first embodiment;

FIG. 2 is a block diagram illustrating one example of a detailed configuration of a terminal apparatus in the first embodiment;

FIG. 3 illustrates one example of a request state held by one terminal apparatus in the first embodiment;

FIG. 4A illustrates one example of the name of content data used by the terminal apparatus in the first embodiment;

FIG. 4B illustrates one example of the name of content data used by the terminal apparatus in the first embodiment;

FIG. 4C illustrates one example of the name of content data used by the terminal apparatus in the first embodiment;

FIG. 4D illustrates one example of the name of content data used by the terminal apparatus in the first embodiment;

FIG. 5 is a block diagram illustrating one example of a detailed configuration of a gateway apparatus in the first embodiment;

FIG. 6 illustrates one example of a request state held by the gateway apparatus in the first embodiment;

FIG. 7 is a flowchart illustrating the operation of one terminal apparatus in the first embodiment;

FIG. 8 is a flowchart illustrating the operation of the gateway apparatus in the first embodiment;

FIG. 9 is a sequence diagram illustrating a processing flow of the content delivery system in the first embodiment;

FIG. 10 is a diagram illustrating one example of the configuration of a content delivery system in a second embodiment;

FIG. 11 is a block diagram illustrating one example of a detailed configuration of a relay apparatus in the second embodiment;

FIG. 12 illustrates one example of a request state held by the relay apparatus in the second embodiment;

FIG. 13 is a diagram illustrating one example of the configuration of a content delivery system in a third embodiment;

FIG. 14 is a block diagram illustrating one example of a detailed configuration of one terminal apparatus in the third embodiment;

FIG. 15A illustrates one example of the name of content data used by the terminal apparatus in the third embodiment;

FIG. 15B illustrates one example of the name of content data used by the terminal apparatus in the third embodiment;

FIG. 15C illustrates one example of the name of content data used by the terminal apparatus in the third embodiment;

FIG. 15D illustrates one example of the name of content data used by the terminal apparatus in the third embodiment;

FIG. 15E illustrates one example of the name of content data used by the terminal apparatus in the third embodiment;

FIG. 15F illustrates one example of the name of content data used by the terminal apparatus in the third embodiment;

FIG. 15G illustrates one example of the name of content data used by the terminal apparatus in the third embodiment;

FIG. 16 is a block diagram illustrating one example of a detailed configuration of a second gateway apparatus in the third embodiment;

FIG. 17 is a flowchart illustrating the operation of one terminal apparatus in the third embodiment; and

FIG. 18 is a flowchart illustrating the operation of the second gateway apparatus in the third embodiment.

### DETAILED DESCRIPTION

In CCN, in order to obtain content data, a user's terminal apparatus sends out a request packet specifying the name of content data itself, not the location of the content data, to a network. Upon receiving the request packet, a content providing apparatus, which provides content, sends out a data packet of the content data corresponding to the name specified by the request packet.

A relay apparatus, which relays a request packet, has routing information called a forwarding information base (FIB). In accordance with the routing information, the relay apparatus transfers a request packet, sent from a terminal apparatus or another relay apparatus, to the content providing apparatus or another relay apparatus. The relay apparatus also has a request storage unit called a pending interest table (PIT) and a data storage unit called a content store. The relay apparatus transfers a data packet, sent from the content providing apparatus or another relay apparatus, to a terminal apparatus that sent a request packet or another relay apparatus.

When the relay apparatus receives a request packet, and a data packet including the name stated in the request packet exists in the data storage unit (the content store), the relay apparatus sends the data packet via an interface via which the request packet was received, without transferring the request packet in accordance with the routing information. On the other hand, when a data packet including the name stated in the received request packet does not exist in the data storage unit (the content store), and an entry corresponding to the name stated in the request packet does not exist in the request storage unit (PIT), the relay apparatus stores, in the request storage unit (PIT), the name stated in the request packet and information about the interface via which the request packet was received. The relay apparatus then transfers the received request packet to the content providing apparatus or another relay apparatus in accordance with the routing information. However, when the name that is the same as the name stated in the request packet exists in the request storage unit (PIT), the relay apparatus does not transfer the request packet in accordance with the routing information and stores, in the same entry as that for the same name that already exists in the request storage unit (PIT), the information about the interface via which the request packet was received.

Upon receiving a data packet, the relay apparatus stores the data packet in the data storage unit (the content store). However, when an area in which the new data packet is to be stored does not exist in the data storage unit (the content store), a data packet that has been stored in the data storage unit (the content store) for a certain amount of time is erased from the data storage area.

In accordance with information in the request storage unit (PIT), the relay apparatus replicates the data packet according to one or more interfaces via which a plurality of request packets stating the name that is the same as the name stated in the data packet were received, and transfers the replicated data packets via the one or more interfaces. Thereafter, the relay apparatus erases, from the request storage unit (PIT), the name in the above-described data packets and information about the interfaces via which the request packets that match the name were received.

In CCN, the relay apparatus can perform data delivery by taking full advantage of the request storage unit (PIT) and the data storage unit (the content store).

However, Patent Document 1 and Non-Patent Document 1 disclose a technique in which a content data name stated in a request packet for obtaining content data and a data packet for transmitting the content data is stated in plaintext (such content data name may hereinafter be referred to as a “plain text content data name” for convenience of description). Thus, on the basis of the plaintext content data name stated in the request packet and the data packet, a packet MAC address, or the like, the relay apparatus and the content providing apparatus can recognize which terminal apparatus sent a request for which content data or which terminal apparatus received which content data. That is, the related art has a problem in that the confidentiality of communication for the terminal apparatuses is not considered.

In order to overcome such a problem, a terminal apparatus according to one aspect of the present disclosure is directed to a terminal apparatus connected to a content-centric network. The terminal apparatus includes: a processor; and a non-transitory memory having stored therein instructions which, when executed by the processor, cause the processor to perform operations that include encrypting a name of content data with a predetermined encryption key to convert the content data name into a first character string and generating a request packet in which a character string including a second character string indicating a name of a gateway apparatus and the first character string is stated as the content data name, and sending the generated request packet to the network.

According to this aspect, it is possible to realize a terminal apparatus, a gateway apparatus, and a relay apparatus that can use a request packet considering the confidentiality of communication and a communication method for the apparatuses.

More specifically, a request packet in which the plaintext name of content data that the terminal apparatus wishes to obtain is encrypted is exchanged between the terminal apparatus and the gateway apparatus. As a result, only the gateway apparatuses can determine which terminal apparatus sent a request for which content data, thus making it possible to ensure the confidentiality of communication for the terminal apparatus.

The operations may further include receiving, as a data packet of the content data, a data packet in which a character string including the second character string and the first character string is stated as a name.

According to this aspect, a request packet in which the plaintext name of content data that the terminal apparatus wishes to obtain is encrypted is exchanged between the terminal apparatus and the gateway apparatus. As a result, only the gateway apparatus can determine which terminal apparatus obtained which content data, thus making it possible to ensure the confidentiality of communication for the terminal apparatus.

The received data packet may be encrypted, and the operations may further include decrypting the received data packet.

The predetermined encryption key may be a public key of a secret key and the public key in a public-key cryptosystem, the secret key and the public key being issued by the gateway apparatus.

According to this aspect, since the public key and the secret key in the public-key cryptosystem are used in communication between terminal apparatuses and the gateway apparatus, results of encryption of the same plaintext content data name become the same for terminal apparatuses that use the same public key. Thus, when the names indicating the gateway apparatus are the same, the names used by the terminal apparatuses and the name used by the gateway apparatus become the same for the same content data. This makes it possible to ensure the confidentiality of communication for the terminal apparatuses while maintaining efficient data delivery performed by the request storage unit and the data storage unit in the relay apparatus, the efficient data delivery being a feature of the CCN.

The gateway apparatus may periodically update the predetermined encryption key.

In the generating of the request packet, the character string including the second character string and the first character string may be further converted into a third character string encrypted with an encryption key different from the predetermined encryption key, and a request packet in which a character string including a fourth character string indicating a name of another gateway apparatus different from that gateway apparatus and the third character string is stated as the content data name may be generated.

In addition, in order to overcome the above-described problem, a gateway apparatus according to one aspect of the present disclosure is directed to a gateway apparatus connected to a content-centric network. The gateway apparatus includes: a processor; and a non-transitory memory having stored therein instructions which, when executed by the processor, cause the processor to perform operations that include receiving, as a name of content data, a request packet including a character string including a second character string indicating a name of the gateway apparatus and an encrypted first character string; converting the received request packet by extracting the encrypted first character string from the received request packet, decrypting the extracted encrypted first character string with a predetermined decryption key, and generating a request packet in which the decrypted first character string is included as the content data name; and sending the converted request packet to the network.

In addition, the operations may further include: receiving a data packet including the content data corresponding to the converted request packet; converting the received data packet by including, in the received data packet as the content data name, a character string including the second character string and the first character string; and sending the converted data packet to a terminal apparatus that sent the received request packet.

The operations may further include holding a sending time of the sent request packet. In the sending of the converted request packet, when a data packet including the content data corresponding to the sent request packet is not received for a predetermined time after the sending time, the request packet may be re-sent.

The operations may further include storing a data packet. When the data packet in which the decrypted first character string is included as the content data name is stored, the converted request packet does not need to be sent to the network, and the stored data packet may be sent to the terminal apparatus as a data packet stating a character string including the second character string and the first character string.

The operations may further include managing the predetermined decryption key and an encryption key corresponding to the predetermined decryption key. The encryption key may be issued to a terminal apparatus connected to the network. The encryption key may be a public key of a secret key and a public key in a public-key cryptosystem, the secret key and the public key being issued to the terminal apparatus, and the predetermined decryption key may be the secret key issued to the terminal apparatus.

In the managing of the secret key, the encryption key and the predetermined decryption key may be periodically updated.

A relay apparatus according to one aspect of the present disclosure is directed to a relay apparatus connected to a content-centric network to relay a request packet and a data packet. The relay apparatus include: a processor; and a non-transitory memory having stored therein instructions which, when executed by the processor, cause the processor to perform operations that include receiving a request packet including a character string in which a second character string indicating a name of the relay apparatus and a first character string is included as a name of content data; converting the received request packet by extracting the first character string from the received request packet, decrypting the extracted first character string with a predetermined decryption key, and generating a request packet in which the decrypted first character string is included as the content data name; and sending the converted request packet to the network.

The operations may further include: receiving a data packet including the content data corresponding to the sent request packet; converting the received data packet by including, in the received data packet as the content data name, a character string including the second character string and the first character string; and sending the converted data packet to a terminal apparatus that sent the received request packet.

A communication method a terminal apparatus according to one aspect of the present disclosure is directed to a communication method for a terminal apparatus connected to a content-centric network to send a request packet stating a name of content data and to receive a data packet including the content data. The communication method includes: encrypting the content data name with a predetermined encryption key to convert the content data name into a first character string and generating a request packet in which a character string including a second character string indicating a name of a gateway apparatus and the first character string is stated as the content data name; and sending the request packet generated in the generating of the request packet to the network.

A communication method for a gateway apparatus according to one aspect of the present disclosure is directed to a communication method for a gateway apparatus connected to a content-centric network. The communication method includes: receiving a request packet including a character string in which a second character string indicating a name of the gateway apparatus and a first character string is included as a name of content data; converting the request packet received in the receiving of the request packet, by extracting the first character string from the received request packet, decrypting the extracted first character string with a predetermined decryption key, and generating a request packet in which the decrypted first character string is included as the content data name; and sending the request packet converted in the converting of the request packet to the network.

A communication method for a relay apparatus according to one aspect of the present disclosure is directed to a communication method for a relay apparatus connected to a content-centric network to relay a request packet and a data packet. The communication method includes: receiving a request packet including a character string in which a second character string indicating a name of the gateway apparatus and a first character string is included as a name of content data; converting the request packet received in the receiving of the request packet, by extracting the first character string from the received request packet, decrypting the extracted first character string with a predetermined decryption key, and generating a request packet in which the decrypted first character string is included as the content data name; and sending the request packet converted in the converting of the request packet to the network.

A terminal apparatus, a gateway apparatus, a relay apparatus, and so on according to embodiments of the present disclosure will be described below in detail with reference to the accompanying drawings.

It should be noted that general or specific embodiments may be implemented as a system, a method, an integrated circuit, a computer program, a storage medium, such as a compact disc read-only memory (CD-ROM), or any selective combination thereof.

### First Embodiment

### [Configuration of Content Delivery System]

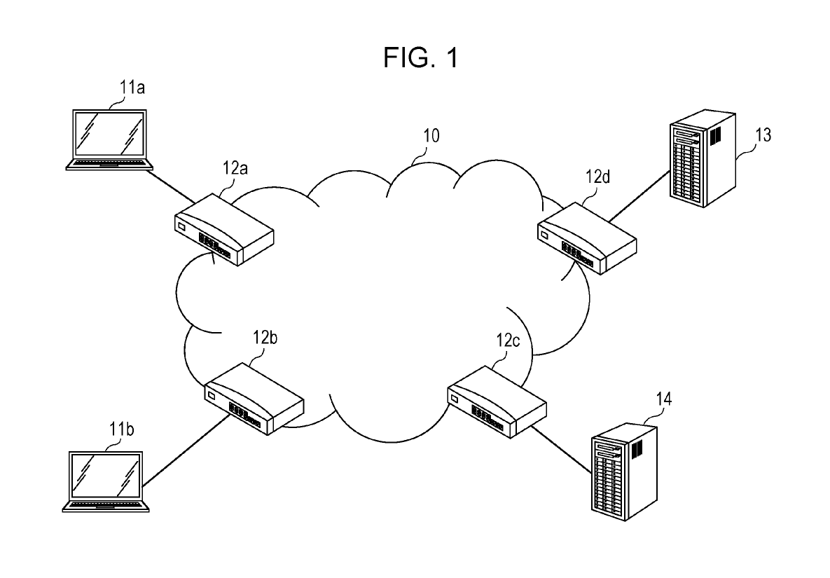

FIG. 1 is a diagram illustrating one example of the configuration of a content delivery system according to a first embodiment.

A content delivery system illustrated in FIG. 1 includes a plurality of terminal apparatuses 11, a plurality of relay apparatuses 12, a content providing apparatus 13, and a gateway apparatus 14, which are connected to each other through a content-centric network (CCN) 10. Terminal apparatuses 11a and 11b are examples of the terminal apparatuses 11, and relay apparatuses 12a, 12b, 12c, and 12d are examples of the relay apparatuses 12.

The CCN 10 is one example of a content-centric network.

The relay apparatuses 12 are connected to the CCN 10 to relay request packets and data packets.

The terminal apparatuses 11 are connected to the CCN 10. Each terminal apparatus 11 sends a request packet for obtaining content data and receives a data packet including the content data through the CCN 10. In the present embodiment, as illustrated in FIG. 1, the terminal apparatuses 11a and 11b can exchange a request packet and a data packet through connection with the CCN 10 via the relay apparatuses 12a and 12b.

The content providing apparatus 13 is connected to the CCN 10 to provide content. More specifically, upon receiving a request packet, the content providing apparatus 13 sends out a data packet of content data corresponding to a content name included in the request packet.

The gateway apparatus 14 is connected to the CCN 10 and relays a request packet sent by each terminal apparatus 11, a data packet sent by the content providing apparatus 13, and a data packet sent by each relay apparatus 12. In the present embodiment, as illustrated in FIG. 1, the gateway apparatus 14 is connected to the CCN 10 via the relay apparatus 12c, thereby making it possible to exchange a request packet and a data packet. As in the present embodiment, a gateway apparatus that acts as a substitute for a terminal apparatus to relay a request packet or the like from the terminal apparatus may be called a proxy.

### [Configuration of Terminal Apparatus]

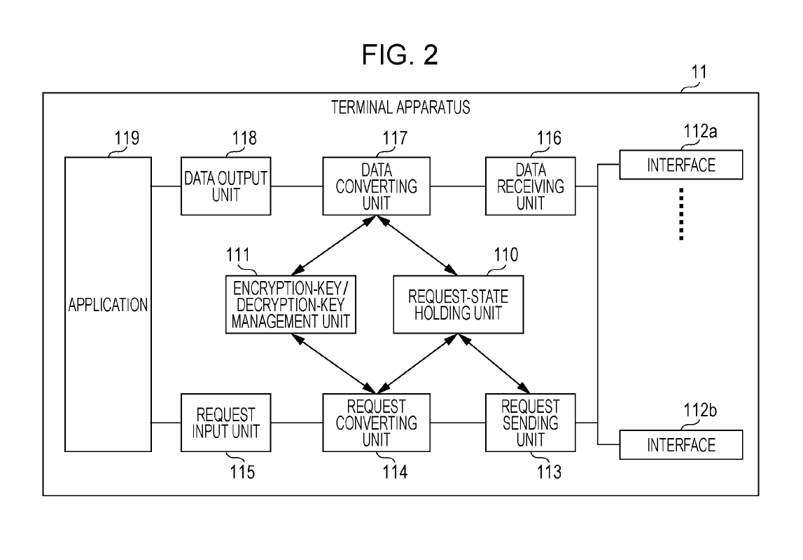

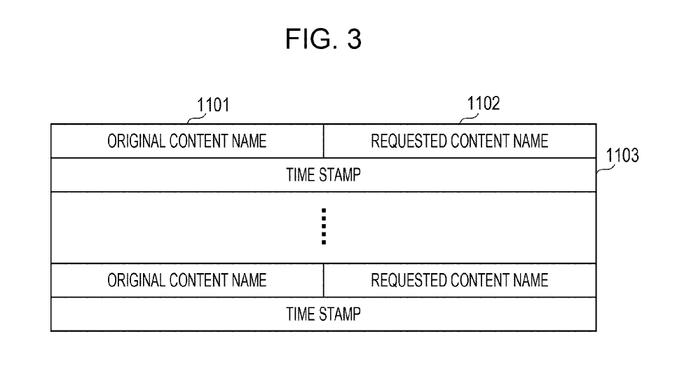

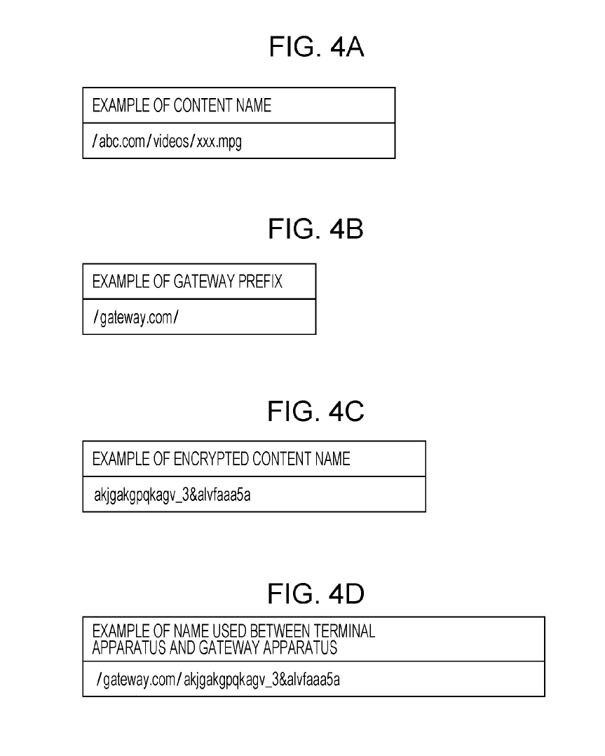

FIG. 2 is a block diagram illustrating one example of a detailed configuration of each terminal apparatus in the first embodiment. FIG. 3 illustrates one example of a request state held by one terminal apparatus in the first embodiment. FIGS. 4A to 4D illustrate one example of names including a plaintext content data name used by terminal apparatus in the first embodiment.

The terminal apparatus 11 illustrated in FIG. 2 includes a request-state holding unit 110, an encryption-key/decryption-key management unit 111, one or more interfaces 112 (interfaces 112a and 112b in FIG. 2), a request sending unit 113, a request converting unit 114, a request input unit 115, a data receiving unit 116, a data converting unit 117, and a data output unit 118. In order to obtain content data indicated by an instruction from an application 119 in the terminal apparatus 11, the terminal apparatus 11 sends a request packet stating the name of the content data (an encrypted name of the content data) and then receives a data packet including the content data.

The request-state holding unit 110 holds the request state. More specifically, the request-state holding unit 110 has an entry including a plurality of items, as illustrated in FIG. 3. For example, the request-state holding unit 110 holds, in an item 1102 in the entry as a requested content name, a character string including the encrypted content data name (the encrypted content name) included in a request packet generated (converted) by the request converting unit 114. For example, the request-state holding unit 110 holds, in an item 1101 as an original content name, the original plaintext content data name (a content name) before it is generated (converted) by the request converting unit 114. In addition, for example, the request-state holding unit 110 holds, in an item 1103 in the item as a time stamp, the sending time of the request packet sent by the request sending unit 113.

The encryption-key/decryption-key management unit 111 manages an encryption key and a decryption key. The encryption key is associated with a predetermined gateway apparatus. In the present embodiment, the encryption key managed by the encryption-key/decryption-key management unit 111 is associated with the gateway apparatus 14. For example, the encryption key is a public key of a secret key and the public key in a public-key cryptosystem, the secret key and the public key being issued by the gateway apparatus 14. The predetermined encryption key is periodically updated by the gateway apparatus 14.

The name of content requested (desired) by a user is input to the request input unit 115 in plaintext. The request input unit 115 notifies the request converting unit 114 of the input plaintext content data name. In the present embodiment, in order to obtain content data, the application 119 inputs the plaintext content data name to the request input unit 115. For instance, in order to obtain content data, the application 119 inputs, for example, “/abc.com/videos/xxx.mpg” illustrated in FIG. 4A to the request input unit 115 as a content data name (a content name). The request input unit 115 then notifies the request converting unit 114 of “/abc.com/videos/xxx.mpg” as a plaintext content data name (a content name).

The request converting unit 114 converts the plaintext content data name into a first character string encrypted with the predetermined encryption key and generates a request packet in which a character string including a second character string indicating the name of the gateway apparatus 14 and the first character string is stated as a content data name (an encrypted content data name).

More specifically, the request converting unit 114 retrieves the encryption key associated with the gateway apparatus 14 from the encryption-key/decryption-key management unit 111, encrypts the plaintext content data name (the content name) by using the retrieved encryption key, and generates a first character string (an encrypted content name) indicating the encrypted content data name. In addition, the request converting unit 114 writes, as a content data name (an encrypted content data name) included in the request packet, a character string in which the first character string (the encrypted content name) is added to the end of a second character string (a gateway prefix) indicating the name of the gateway apparatus 14. The request converting unit 114 then records, to an item in an entry in the request-state holding unit 110, the plaintext content data name (the content name) and the character string in which the first character string is stated at the end of the second character string.

In the present embodiment, by using the encryption key retrieved from the encryption-key/decryption-key management unit 111, the request converting unit 114 encrypts, for example, “/abc.com/videos/xxx.mpg”, which is a character string of a plaintext content data name (a content name) illustrated in FIG. 4A, to generate, for example, “akjgakgpqkagv_{—}3&alvfaaa5a” illustrated in FIG. 4C as a first character string, which is an encrypted content data name (an encrypted content name). In addition, the request converting unit 114 writes, as a content data name (an encrypted content data name) included in the request packet, for example, a character string “/gateway.com/akjgakgpqkagv_{—}3&alvfaaa5a” (illustrated in FIG. 4D) in which, for example, the first character string is added to the end of “/gateway.com/” (illustrated in FIG. 4B), which is a second character string (a gateway prefix) indicating the name of the gateway apparatus 14. The request converting unit 114 then records the plaintext content data name (the content name) “/abc.com/videos/xxx.mpg” to the item 1101 in the entry in the request-state holding unit 110 as an original content name and records the character string “/gateway.com/akjgakgpqkagv_{—}3&alvfaaa5a” in which the first character string is stated at the end of the second character string to the item 1102 in the entry in the request-state holding unit 110 as a requested content name.

The request sending unit 113 sends the request packet generated by the request converting unit 114 to the CCN 10. In the present embodiment, the request sending unit 113 sends a request packet in which “/gateway.com/akjgakgpqkagv_{—}3&alvfaaa5a” (the character string in which the first character string is stated at the end of the second character string) to the CCN 10 through the interface 112 as the content data name (the encrypted content data name).

The request sending unit 113 records the sending time of the request packet sent by the CCN 10 to the request-state holding unit 110. When a predetermined time passes from the sending time held by the request-state holding unit 110, the request sending unit 113 may re-send the request packet.

More specifically, the request sending unit 113 records the sending time to an item 1103 in the entry, held by the request-state holding unit 110, as a time stamp. In this case, the sending time is recorded to the item 1103 in an entry of one or more entries which matches the character string “/gateway.com/akjgakgpqkagv_{—}3&alvfaaa5a” in which the first character string is stated at the end of the second character string. The request sending unit 113 refers to the item 1103 (the time stamp) in the entry in the request-state holding unit 110, and when a predetermined time passes from a previous request sending time, the request sending unit 113 may update the item 1103 (the time stamp) by re-sending the request packet in which the item 1102 (the requested content name) in the entry is stated.

The request packet sent from the terminal apparatus 11 to the CCN 10 is transferred to the gateway apparatus 14, on the basis of the name (a gateway prefix) of the gateway apparatus 14 which is included in the content data name (the encrypted content data name) stated in the above-described request packet and in accordance with routing-control information held by the relay apparatuses 12 (the relay apparatuses 12a to 12c and so on).

The data receiving unit 116 receives, as a data packet of the content data, the data packet in which the character string including the second character string and the first character string is stated as the content data name (the encrypted content data name). In the present embodiment, the data receiving unit 116 receives, via the interface 112, a data packet having, as a name, the character string in which the first character string is added to the end of the second character string.

The data converting unit 117 refers to the item 1102 (the requested content name) in the entry held by the request-state holding unit 110. On the basis of the item 1101 (the original content name) in the entry including the item 1102 (the requested content name) corresponding to the character string in which the first character string is added to the end of the second character string, the data converting unit 117 converts the data packet received by the data receiving unit 116 into a data packet stating the plaintext content data name indicated by the item 1101 (the original content name). The data converting unit 117 then deletes the entry including the item 1102 (the requested content name) from the request-state holding unit 110.

When the data packet received by the data receiving unit 116 is encrypted, the data converting unit 117 obtains the decryption key associated with the gateway apparatus 14 from the encryption-key/decryption-key management unit 111 and decrypts the data packet. Thus, when the content data received by the data receiving unit 116 is encrypted, the data converting unit 117 can decrypt the content data by using the decryption key associated with the gateway apparatus 14.

The data output unit 118 outputs, to the application 119, the data packet corresponding to the plaintext content data name converted by the data converting unit 117.

### [Configuration of Gateway Apparatus]

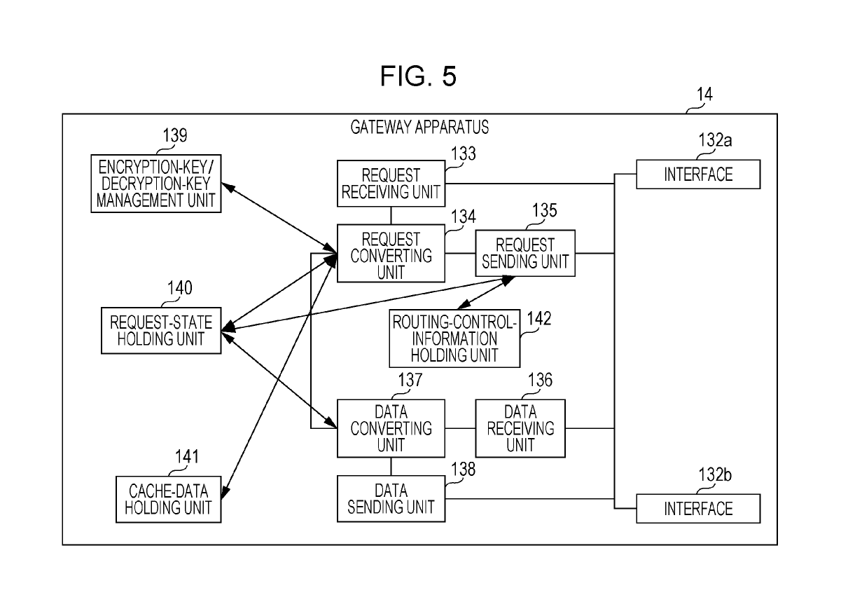

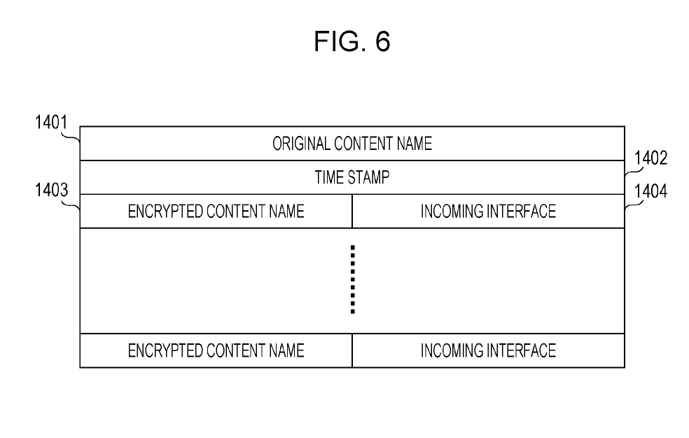

FIG. 5 is a block diagram illustrating one example of a detailed configuration of the gateway apparatus in the first embodiment. FIG. 6 illustrates one example of a request state held by the gateway apparatus in the first embodiment.

The gateway apparatus 14 illustrated in FIG. 5 includes one or more interfaces 132 (interfaces 132a and 132b), a request receiving unit 133, a request converting unit 134, a request sending unit 135, a data receiving unit 136, a data converting unit 137, a data sending unit 138, an encryption-key/decryption-key management unit 139, a request-state holding unit 140, a cache-data holding unit 141, and a routing-control-information holding unit 142. As described above, the gateway apparatus 14 relays a request packet sent by the terminal apparatus 11, a data packet sent by the content providing apparatus 13, and a data packet sent by the relay apparatus 12.

The request-state holding unit 140 holds a request state. For example, the request-state holding unit 140 holds the sending time of a request packet sent by the request sending unit 135. More specifically, the request-state holding unit 140 has an entry including a plurality of items, as illustrated in FIG. 6. For example, the request-state holding unit 140 holds the plaintext content data name (the content name), included in a request packet decrypted by the request converting unit 134, in an item 1401 in the entry by using an original content name as key information. In addition, for example, the request-state holding unit 140 holds the name, included in the request packet received by the request receiving unit 133, in an item 1403 in the entry as an encrypted content name. The request-state holding unit 140 also holds, in an item 1404 in the entry as an incoming interface, information about the interface 132 via which the request packet was received. The request-state holding unit 140 further holds, in an item 1402 in the entry as a time stamp, the sending time of the request packet sent by the request sending unit 135.

The encryption-key/decryption-key management unit 139 manages a predetermined decryption key and an encryption key corresponding to the predetermined decryption key. The encryption-key/decryption-key management unit 139 issues the predetermined encryption key to the terminal apparatus 11 connected to the CCN 10. The encryption-key/decryption-key management unit 139 periodically updates the predetermined encryption key and decryption key. In this case, the predetermined encryption key may be a public key of a secret key and the public key in a public-key cryptosystem, the secret key and the public key being issued by the encryption-key/decryption-key management unit 139, and the predetermined decryption key may be the secret key issued by the encryption-key/decryption-key management unit 139.

The request receiving unit 133 receives a request packet in which a character string including the second character string indicating the name of the gateway apparatus 14 (local apparatus) and the first character string is included as the content data name (the encrypted content data name). In the present embodiment, the request receiving unit 133 receives, via the interface 132, the request packet in which the character string in which the first character string is added to the end of the second character string is stated as the name.

The request converting unit 134 converts the request packet received by the request receiving unit 133, by extracting the first character string from the request packet received by the request receiving unit 133, decrypting the extracted first character string with the predetermined decryption key, generating a request packet including the decrypted first character string as a content data name (plaintext content data name).

In the present embodiment, the request converting unit 134 extracts, as the encrypted content data name (the encrypted content name), the first character string “akjgakgpqkagv_{—}3&alvfaaa5a” from the character string “/gateway.com/akjgakgpqkagv_{—}3&alvfaaa5a”, which is the name stated in the request packet received by the request receiving unit 133 and in which the first character string is added to the end of the second character string. By using the predetermined decryption key retrieved from the encryption-key/decryption-key management unit 139, the request converting unit 134 decrypts the first character string “akjgakgpqkagv_{—}3&alvfaaa5a” to obtain “/abc.com/videos/xxx.mpg” as a character string indicating the plaintext content data name (the content name). In this case, the predetermined decryption key is associated in some way with the name (the gateway prefix) of the gateway apparatus 14 (the local apparatus) and the terminal apparatus 11 that sent the request. The request converting unit 134 then generates a new request packet in which the character string “/abc.com/videos/xxx.mpg” is stated as a plaintext content data name (a content name). In the manner described above, the request converting unit 134 converts the request packet received by the request receiving unit 133.

In addition, the request converting unit 134 records the character string “/abc.com/videos/xxx.mpg”, which indicates the decrypted plaintext content data name (content name), to the item 1401 in the entry in the request-state holding unit 140 as an original content name and records the character string “akjgakgpqkagv_{—}3&alvfaaa5a”, which indicates the encrypted content data name (the encrypted content name) stated in the request packet, to the item 1403 in the entry in the request-state holding unit 140 as an encrypted content name. The request converting unit 134 also records information about the interface 132 via which the above-described request packet was received to the item 1404 in the entry in the request-state holding unit 140 as an incoming interface.

The routing-control-information holding unit 142 holds routing information.

The request sending unit 135 sends the request packet converted by the request converting unit 134 to the CCN 10. In the present embodiment, the request sending unit 135 sends the request packet stating the character string “/abc.com/videos/xxx.mpg”, which indicates the decrypted plaintext content data name (content name), to the CCN 10 via the interface 132. In this case, the request sending unit 135 sends the request packet stating the plaintext content data name (the content name) to the CCN 10 via the selected interface 132 in accordance with the routing information held by the routing-control-information holding unit 142.

The request sending unit 135 records the sending time of the request packet, sent by the CCN 10, to the request-state holding unit 140. In this case, the request sending unit 135 may re-send the request packet when a predetermined time passes after the sending time held by the request-state holding unit 110. The request sending unit 135 may also re-send the request packet when the data receiving unit 136 does not receive a data packet including content data corresponding to the request packet sent by the request sending unit 135 for a predetermined time after the above-described sending time.

More specifically, the request sending unit 135 records the sending time to the item 1402 in the entry, held by the request-state holding unit 140, as a time stamp. The request sending unit 135 also refers to the item 1402 (the time stamp) in the entry held by the request-state holding unit 140, and when a predetermined time passes from the previous request sending time, or when the data receiving unit 136 does not receive a data packet corresponding to the request packet for a predetermined time after the previous request sending time, the request sending unit 135 may update the item 1402 (the time stamp) by re-sending the request packet stating the item 1401 (the original content name) in the entry.

The request packet sent from the gateway apparatus 14 to the CCN 10 is transferred in the CCN 10 in accordance with the routing-control information held by the relay apparatuses 12 (the relay apparatuses 12a to 12d and so on). When the content providing apparatus 13 or the relay apparatus 12 in which a data packet corresponding to the request packet is cached (stored) receives the request packet, it sends content data (the data packet) corresponding to the plaintext content data name (the content name) included in the received request packet to the gateway apparatus 14.

The data receiving unit 136 receives the data packet including the content data corresponding to the request packet sent by the request sending unit 135. In the present embodiment, the data receiving unit 136 receives, via the interface 132, a data packet stating the character string “/abc.com/videos/xxx.mpg” indicating the plaintext content data name (the content name) included in the request packet sent by the request sending unit 135.

The data converting unit 137 converts the data packet received by the data receiving unit 136, by including, in the data packet received by the data receiving unit 136 as a content data name (an encrypted content data name), the character string including the second character string and the first character string. More specifically, the data converting unit 137 refers to the item 1401 (the original content name) in the entry held by the request-state holding unit 140. The data converting unit 137 obtains, from the item 1403 (the encrypted content name) and the item 1404 (the incoming interface) in the entry corresponding to the plaintext content data name (the content name) included in the data packet received by the data receiving unit 136, the character string “/gateway.com/akjgakgpqkagv_{—}3&alvfaaa5a” in which the first character string is added to the end of the second character string and information about one or more interfaces 132 via which the request packet was received. Next, the data converting unit 137 converts the data packet stating the plaintext content data name (the content name) into the data packet stating the character string “/gateway.com/akjgakgpqkagv_{—}3&alvfaaa5a” in which the first character string is added to the end of the second character string. The data converting unit 137 then deletes, from the request-state holding unit 140, the entry including the item 1401 (the original content name) that matches the plaintext content data name (the content name) included in the data packet received by the data receiving unit 136.

The data sending unit 138 sends the data packet converted by the data converting unit 137 to the terminal apparatus 11 that sent the request packet received by the request receiving unit 133. More specifically, the data sending unit 138 sends, to the terminal apparatus(es) 11 via one or more interfaces 132 stated in the item 1404 (the incoming interface) in the entry, the data packet that was converted by the data converting unit 137 and in which the character string “/gateway.com/akjgakgpqkagv_{—}3&alvfaaa5a” in which the first character string is added to the end of the second character string is included as a content data name (an encrypted content data name). The data packet sent from the gateway apparatus 14 to the CCN 10 is transferred to the terminal apparatus 11 on the basis of the name stated in the data packet and in accordance with a request storage unit (PIT) held by the relay apparatus 12.

The data converting unit 137 may also store, in the cache-data holding unit 141, a data packet received by the data receiving unit 136 and having the plaintext content data name.

Also, by using the predetermined encryption key obtained from the encryption-key/decryption-key management unit 139, the data converting unit 137 may encrypt the content data included in the data packet sent to the terminal apparatus 11. This makes it possible to further enhance the confidentiality of communication between the terminal apparatus 11 and the gateway apparatus 14. However, it is assumed that this encryption key is associated in some way with the name indicating the gateway apparatus 14 and the terminal apparatus 11.

When a data packet stating the plaintext content data name (the content name) exists in the cache-data holding unit 141, the request sending unit 135 does not necessarily have to send a request packet stating the plaintext content data name (the content name). In this case, the data sending unit 138 may immediately send, to the terminal apparatus 11, the data packet in which the character string including the second character string and the first character string is included as a content data name (an encrypted content data name).

More specifically, when a data packet stating the plaintext content data name (the content name) exists in the cache-data holding unit 141, the request converting unit 134 does not store information of the received request in the request-state holding unit 140 and notifies the data converting unit 137 of the character string that is included in the received request packet and that includes the second character string and the first character string, the plaintext content data name (the content name) obtained by decrypting the first character string, and the information about the interface 132 via which the request packet was received. By using the information received from the request converting unit 134, the data converting unit 137 generates a data packet in which the character string including the second character string and the first character string is included as a content data name (an encrypted content data name), on the basis of the data packet including the plaintext content data name (the content name) stored in the cache-data holding unit 141. The data packet in which the character string including the second character string and the first character string is included as a content data name (an encrypted content data name) is sent from the data sending unit 138 to the terminal apparatus 11 via the interface 132 via which the above-described request packet was received. Thus, when the plurality of terminal apparatuses 11 attempt to obtain the content data stating the same content data name (content name), the gateway apparatus 14 can reduce the number of request packets to be sent and can quickly send the data packet to the terminal apparatuses 11.

Also, when there are a plurality of character strings including the second character string and the first character string corresponding to the plaintext content data name (the content name) included in the data packet received by the data receiving unit 136, the data converting unit 137 converts the data packet received by the data receiving unit 136 into data packets stating the respective character strings. The data sending unit 138 then sends the data packets to the terminal apparatuses 11 via one or more interfaces 132 stated in the item 1404 (the incoming interface) in the entry including the character string. The data converting unit 117 deletes, from the request-state holding unit 110, all entries including the item 1401 (the encrypted content name) that matches the plaintext content data name (the content name) included in the data packet received by the data receiving unit 136.

Also, when the plaintext content data name (the content name) is obtained before the request converting unit 134 converts the request packet received by the request receiving unit 133 into a request packet stating the plaintext content data name (the content name), there is a case in which the request-state holding unit 140 already holds an entry in which the plaintext content data name is stored in, for example, the item 1401 (the original content name) illustrated in FIG. 6. In this case, the request converting unit 134 determines that a request packet stating the plaintext content data name (the content name) has already been sent from the request sending unit 135 and the gateway apparatus 14 is waiting for receiving a data packet stating the plaintext content data name (the content name), and thus the request converting unit 134 does not need to convert the request packet received by the request receiving unit 133 into a request packet stating the plaintext content data name (the content name). That is, the request sending unit 135 does not necessarily have to newly send a request packet stating the plaintext content data name (the content name), and the data receiving unit 136 may wait for receiving a data packet stating the plaintext content data name (the content name). With this arrangement, when the plurality of terminal apparatuses 11 send request packets at substantially the same time in order to obtain content data stating the same plaintext content data name (content name), it is possible to reduce the number of request packets to be sent from the gateway apparatus 14. That is, it is possible to reduce traffic in the CCN 10.

When pieces of information that are the same as information already held in the item 1401 (the original content name), the item 1403 (the encrypted content name), and the item 1404 (the incoming interface) are to be recorded to the request-state holding unit 140, no information may be recorded thereto by using the item 1401 (the original content name) as key information in order to reduce the amount of memory in the request-state holding unit 140, assuming that the same entry already exists. Also, when pieces of information that are the same as information already held in the item 1401 (the original content name) and the item 1403 (the encrypted content name) are to be recorded, information about the interface 132 via which the request packet was received may only be added to the item 1404 (the incoming interface) that is paired with the item 1403 (the encrypted content name). In addition, when information that is the same as only information already held in the item 1401 (the original content name) is to be recorded, the name stated in the request packet and the information about the interface 132 via which the request packet was received may only be added to the item 1403 (the encrypted content name) and the item 1404 (the incoming interface) that is paired with the item 1403 (the encrypted content name).

### [Operation of Terminal Apparatus]

Next, a description will be given of the operation of the terminal apparatus 11 configured as described above.

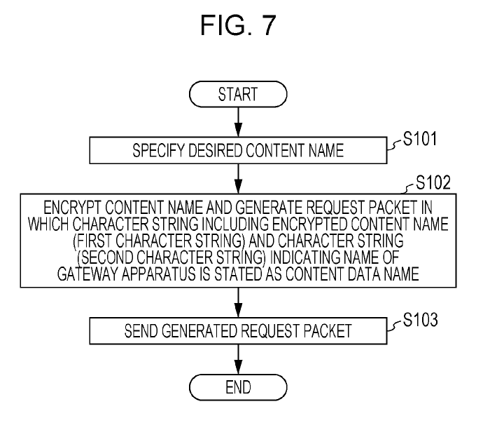

FIG. 7 is a flowchart illustrating the operation of one terminal apparatus in the first embodiment. FIG. 7 illustrates an operation until a request packet is sent, the operation being a characteristic operation of the terminal apparatus 11.

First, the user or an application specifies a desired content name. In the present embodiment, the application 119 inputs a desired plaintext content data name to the request input unit 115 in the terminal apparatus 11 (S101).

Next, the terminal apparatus 11 (the request converting unit 114) encrypts the plaintext content data name with the predetermined encryption key and generates a request packet in which a character string including the encrypted content name (a first character string) and a character string (a second character string) indicating the name of the gateway apparatus 14 is stated as a content data name (an encrypted content data name) (S102).

Next, the terminal apparatus 11 (the request sending unit 113) sends the generated request packet to the CCN 10 (S103).

As described above, the terminal apparatus 11 can generate a request packet considering the confidentiality of communication.

### [Operation of Gateway Apparatus]

Next, a description will be given of the operation of the gateway apparatus 14 configured as described above.

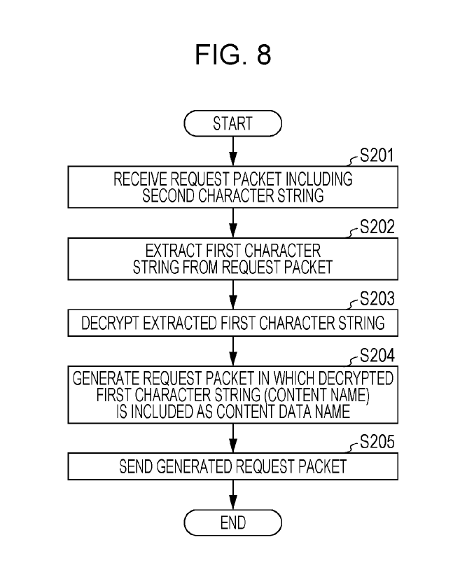

FIG. 8 is a flowchart illustrating the operation of the gateway apparatus in the first embodiment. FIG. 8 illustrates an operation from when a request packet is received until it is sent, the operation being a characteristic operation of the gateway apparatus 14.

First, the gateway apparatus 14 receives a request packet including the second character string indicating the name of the local apparatus (S201). In the present embodiment, the gateway apparatus 14 (the request receiving unit 133) receives a request packet in which a character string including the second character string indicating the name of the gateway apparatus 14 (the local apparatus) and the first character string is stated as a content data name (an encrypted content data name).

Next, the gateway apparatus 14 extracts the first character string from the request packet received in S201 (S202), decrypts the extracted first character string with the predetermined decryption key (S203), and generates a request packet in which the decrypted first character string is included as a plaintext content data name (S204).

Next, the gateway apparatus 14 sends the request packet generated in S204 to the CCN 10 (S205).

As described above, considering the confidentiality of communication, the gateway apparatus 14 can convert a request packet stating an encrypted content data name into a plaintext content data name and can send the plaintext content data name to the CCN 10.

### [Operation of Content Delivery System]

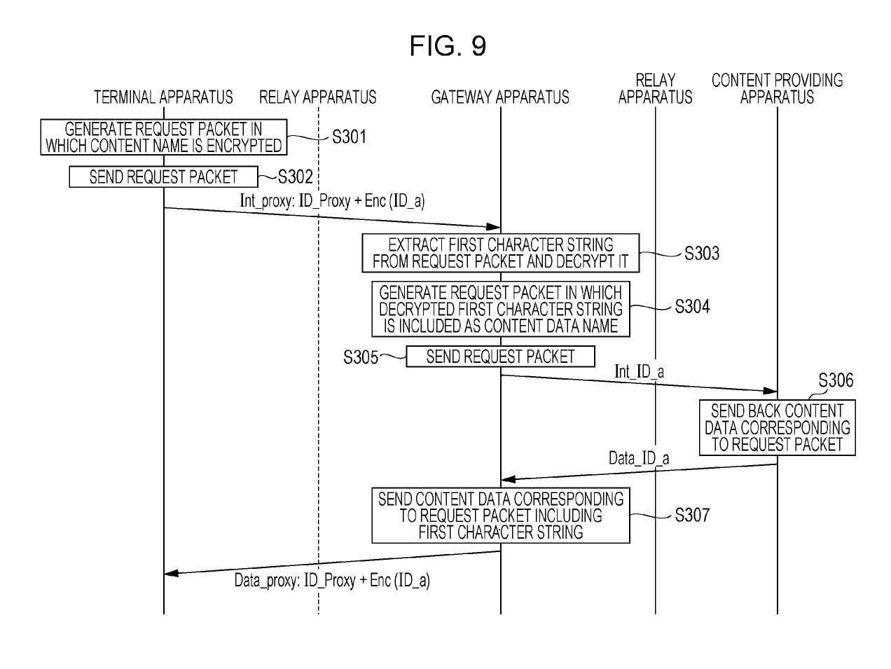

FIG. 9 is a sequence diagram illustrating a processing flow of the content delivery system in the first embodiment. FIG. 9 illustrates an operation in which the terminal apparatus 11 sends a request packet until it receives content data.

First, the terminal apparatus 11 generates a request packet in which a content name is encrypted (S301). More specifically, the terminal apparatus 11 encrypts a plaintext content data name with the predetermined encryption key and generates a request packet in which a character string in which the encrypted content name (the first character string) is added to the end of a character string (the second character string) indicating the name of the gateway apparatus 14 is stated as a content data name (an encrypted content data name).

Next, the terminal apparatus 11 sends the generated request packet to the CCN 10 (S302). In this case, in “Int_Proxy: ID_Proxy+Enc(ID_a)” in FIG. 9, “Int_Proxy” means a request packet for the gateway apparatus 14. “ID_Proxy” means the second character string indicating the name of the gateway apparatus 14, and “Enc(ID_a)” means the first character string obtained by encrypting the plaintext content data name with the predetermined encryption key. Thus, “ID_Proxy+Enc(ID_a)” means the character string in which the encrypted content name (the first character string) is added to the end of the character string (the second character string) indicating the name of the gateway apparatus 14.

Next, the gateway apparatus 14 receives the request packet including the second character string indicating the name of the local apparatus, extracts the first character string from the received request packet, and decrypts the extracted first character string with the predetermined decryption key (S303).

Next, the gateway apparatus 14 generates a request packet in which the decrypted first character string is included as a plaintext content data name (S304).

Next, the gateway apparatus 14 sends the generated request packet to the CCN 10 (S305). In this case, in “Int_ID_a” in FIG. 9, “ID_a” means a plaintext content data name, and “Int_ID_a” means a request packet stating the plaintext content data name.

After S305, the content providing apparatus 13 receives the request packet stating the plaintext content data name and sends back content data corresponding to the received request packet to the CCN 10 (S306). In this case, in “Data_ID_a” in FIG. 9, “ID_a” means the plaintext content data name, and “Data_ID_a” means the data packet stating the plaintext content data name.

After S306, the gateway apparatus 14 receives the data packet corresponding to the sent request packet and sends content data corresponding to the request packet in which the content name is encrypted (S307). More specifically, the gateway apparatus 14 receives the data packet including content data corresponding to the sent request packet, and converts the data packet received by the data receiving unit 136, by including, in the received data packet as a content data name (an encrypted content data name), a character string in which the first character string is added to the end of the second character string. The gateway apparatus 14 then sends, to the terminal apparatus 11, the data packet in which the content data name is converted (the data packet in which the plaintext content data name is encrypted).

In this case, in “Data_Proxy: ID_Proxy+Enc(ID_a)”, “Data_Proxy” means the data packet from the gateway apparatus 14. “ID_Proxy” means the second character string indicating the name of the gateway apparatus 14, and “Enc(ID_a)” means the first character string obtained by encrypting the plaintext content data name with the predetermined encryption key. Thus, “ID_Proxy+Enc(ID_a)” means a character string obtained by adding the encrypted content name (the first character string) to the end of the character string (second character string) indicating the name of the gateway apparatus 14.

### Advantages of First Embodiment, Etc

As described above, according to the present embodiment, it is possible to realize a terminal apparatus, and a gateway apparatus that can use a request packet considering the confidentiality of communication and a communication method for the apparatuses.

More specifically, according to the present embodiment, communication between the terminal apparatus 11 and the gateway apparatus 14 is performed using a request packet in which the plaintext name of content data that the terminal apparatus 11 wishes to obtain is concealed (encrypted). As a result, only the gateway apparatus 14 can determine which terminal apparatus 11 sent a request for which content data, thus making it possible to ensure the confidentiality of communication for the terminal apparatuses 11.

In addition, according to the present embodiment, communication between the terminal apparatus 11 and the gateway apparatus 14 can be performed using a data packet in which the plaintext name of content data that the terminal apparatus 11 wishes to obtain is concealed (encrypted). As a result, only the gateway apparatus 14 can determine which terminal apparatus 11 obtained which content data, thus making it possible to ensure the confidentiality of communication for the terminal apparatuses 11.

In addition, according to the present embodiment, since a public key and a secret key in the public-key cryptosystem are used in communication between the terminal apparatus 11 and the gateway apparatus 14, the results (the encrypted content name) of the encryption on the same plaintext content data name (content name), the encryption being performed by the plurality of terminal apparatuses 11 that use the same public key, become the same. Thus, when the names (gateway prefixes) indicating the gateway apparatus 14 are the same, the names used by the plurality of terminal apparatuses 11 and the name used by the gateway apparatus 14 become the same for the same content data. As a result, it is possible to ensure the confidentiality of communication, while maintaining efficient data delivery performed by the request storage unit and the data storage unit in the relay apparatus 12, the efficient data delivery being a feature of the CCN.

Although a character string in which the first character string is stated at the end of the second character string is used between the terminal apparatus 11 and the gateway apparatus 14, the present disclosure is not limited thereto. It is sufficient as long as a character string including the second character string and the first character string is stated.

Also, although the gateway prefix has been described above as an example of a character indicating the name of the gateway apparatus 14, the present disclosure is not limited thereto. The character string may also be part of the name indicating the gateway apparatus 14 or a character string associated with the gateway apparatus 14, as long as a request packet arrives at the gateway apparatus 14 when the character string is stated in the request packet.

### Second Embodiment

Although an example of a case in which the gateway apparatus 14 is incorporated into the CCN 10 has been described in the first embodiment, the present disclosure is not limited thereto. One relay apparatus 12 may also include the functions of the gateway apparatus 14 in the first embodiment. In a second embodiment, such a case will be described.

### [Configuration of Content Delivery System]

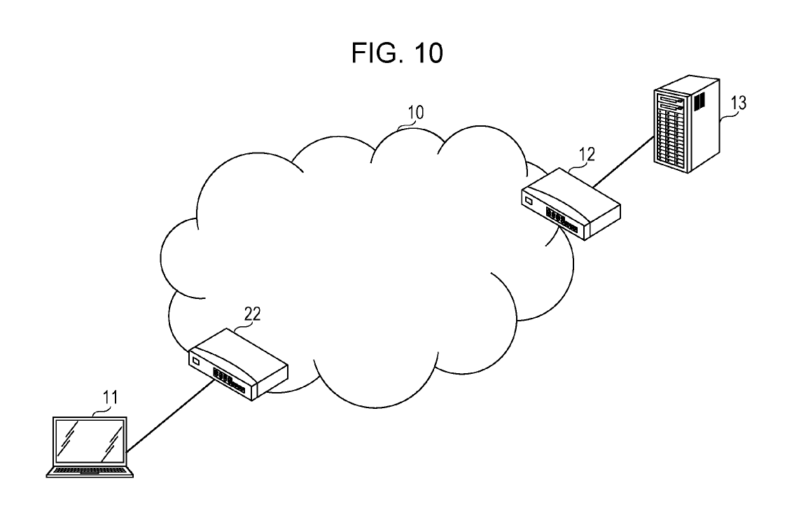

FIG. 10 is a diagram illustrating one example of the configuration of a content delivery system in the second embodiment. Elements that are the same as or similar to those in FIG. 1 are denoted by the same reference numerals, and detailed descriptions thereof are not given hereinafter.

The configuration of a relay apparatus 22 in the content delivery system illustrated in FIG. 10 differs from that in the content delivery system illustrated in FIG. 1 according to the first embodiment. Since the relay apparatus 12 is substantially the same as that described in the first embodiment, a description thereof is not given hereinafter.

The relay apparatus 22 is connected to the CCN 10 to relay a request packet and a data packet. The relay apparatus 22 also has the functions of the gateway apparatus 14 in the first embodiment.

In the present embodiment, as illustrated in FIG. 10, the relay apparatus 22 can exchange a request packet and a data packet with the terminal apparatus 11, another relay apparatus (the relay apparatus 12), or the content providing apparatus 13.

In the present embodiment, in order to obtain content data corresponding to a plaintext content data name (a content name), the terminal apparatus 11 sends a request packet stating a character string in which the first character string is added to the end of the second character string. The request packet is then transferred to the relay apparatus 22 on the basis of the second character string stated in the request packet.

### [Configuration of Relay Apparatus]

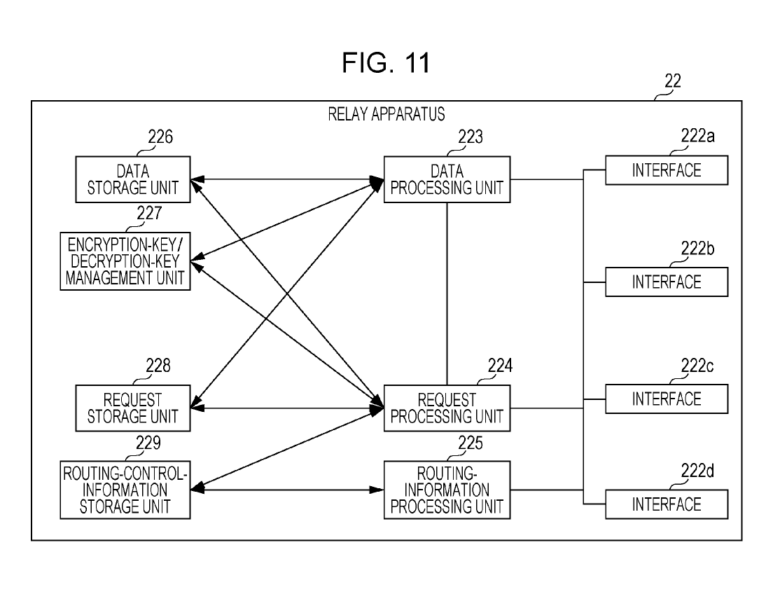

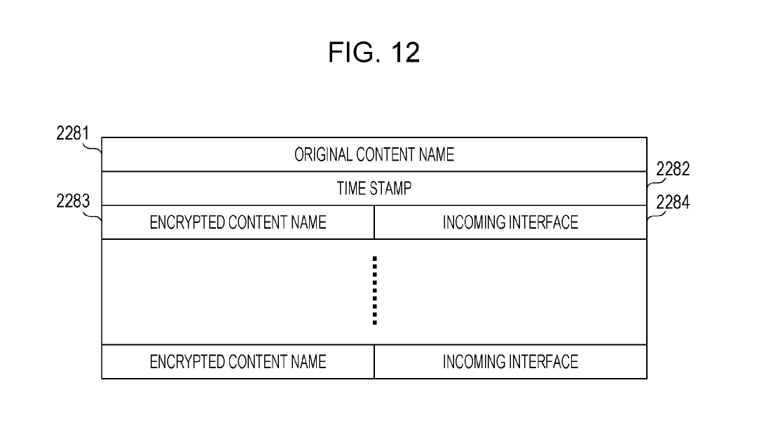

FIG. 11 is a block diagram illustrating one example of a detailed configuration of the relay apparatus in the second embodiment. FIG. 12 illustrates one example of a request state held by the relay apparatus in the second embodiment.

The relay apparatus 22 illustrated in FIG. 11 has the functions of the gateway apparatus 14. More specifically, the relay apparatus 22 includes one or more interfaces 222 (interfaces 222a to 222d), a data processing unit 223, a request processing unit 224, a routing-information processing unit 225, a data storage unit 226, an encryption-key/decryption-key management unit 227, a request storage unit 228, and a routing-control-information storage unit 229. The relay apparatus 22 relays a request packet sent by the terminal apparatus 11, a data packet sent by the content providing apparatus 13, or a request packet or data packet sent by the other relay apparatus 12. Differences from a known relay apparatus will be mainly described below. It is assumed that the relay apparatus 12 or the like transfers all request packets including a character (the gateway prefix in FIG. 4B) indicating the name of the gateway apparatus 14 to the relay apparatus 22.

The request storage unit 228 has functions of a pending interest table (PIT) and further stores a request state as illustrated in FIG. 12. Since the PIT is related art, the description below will be given of the request state. The request storage unit 228 has an entry including a plurality of items, as illustrated in FIG. 12. For example, the request storage unit 228 holds a plaintext content data name (a content name), included in the request packet decrypted by the request processing unit 224, in an item 2281 in the entry as an original content name. For example, the request storage unit 228 holds an encrypted content data name (an encrypted content name), included in the request packet received by the request processing unit 224 and not yet decrypted by the request processing unit 224, in an item 2283 in the entry as an encrypted content name. The request storage unit 228 also holds, in an item 2284 in the entry as an incoming interface, information about the interface 222 via which the request packet was received. The request storage unit 228 also stores, in an item 2282 in the entry as a time stamp, the sending time of the request packet sent by the request processing unit 224.

When pieces of information that are the same as information already stored in the item 2281 (the original content name), the item 2283 (the encrypted content name), and the item 2284 (the incoming interface) are to be recorded to the request storage unit 228, no information may be recorded thereto by using the item 2281 (the original content name) as key information in order to reduce the amount of memory in the request storage unit 228, assuming that the same entry already exists, as in the first embodiment. Also, when pieces of information that are the same as information already held in the item 2281 (the original content name) and the item 2283 (the encrypted content name) are to be recorded, information about the interface 222 via which the request packet was received may only be added to the item 2284 (the incoming interface) that is paired with the item 2283 (the encrypted content name). In addition, when information that is the same as only information already held in the item 2281 (the original content name) is to be recorded, the name stated in the request packet and the information about the interface 222 via which the request packet was received may only be added to the item 2283 (the encrypted content name) and the item 2284 (the incoming interface) that is paired with the item 2283 (the encrypted content name).

The encryption-key/decryption-key management unit 227 manages a predetermined decryption key and an encryption key corresponding to the predetermined decryption key. The encryption-key/decryption-key management unit 227 issues the predetermined encryption key to the terminal apparatus 11 connected to the CCN 10. The encryption-key/decryption-key management unit 227 periodically updates the predetermined encryption key and the decryption key. In this case, the predetermined encryption key may be a public key of a secret key and the public key in a public-key cryptosystem, the secret key and the public key being issued by the encryption-key/decryption-key management unit 227, and the predetermined decryption key may be the secret key issued by the encryption-key/decryption-key management unit 227.

The routing-control-information storage unit 229 has routing information held by a routing-information storage unit called a forwarding information base (FIB)”. In accordance with the routing information, the relay apparatus 22 transfers the request packet sent from the terminal apparatus 11 or the other relay apparatus 12.

The request processing unit 224 has functions of the request receiving unit 133, the request converting unit 134, and the request sending unit 135 in the gateway apparatus 14 in the first embodiment, in addition to the functions of the request transfer processing of the known relay apparatus. That is, the request processing unit 224 receives a request packet in which the character string including the second character string indicating the name of the gateway apparatus 14 (the local apparatus) and the first character string is included as a content data name (an encrypted content data name). The request processing unit 224 also converts the received request packet by extracting the first character string from the received request packet, decrypting the extracted first character string with the predetermined decryption key, and generating a request packet in which the decrypted first character string is included as a plaintext content data name. The request processing unit 224 sends the converted request packet to the CCN 10.

In the present embodiment, the request processing unit 224 receives, via the interface 222, the request packet in which a character string in which the first character string is added to the end of the second character string is stated as a name. When the character string indicating the content data name (the encrypted content data name) stated in the received request packet includes a character (the gateway prefix in FIG. 4B) indicating the name of the gateway apparatus 14, the request processing unit 224 extracts the first character string indicating the encrypted content data name (the encrypted content name) from the character string in which the first character string added to the end of the second character string. By using the predetermined decryption key retrieved from the encryption-key/decryption-key management unit 227, the request processing unit 224 decrypts the first character string to obtain the character string indicating the plaintext content data name (the content name). In this case, it is assumed that the decryption key is associated in some way with the gateway prefix illustrated in FIG. 4B and the terminal apparatus 11 that sent the request.

The request processing unit 224 further records the character string indicating the decrypted plaintext content data name (content name), the character string indicating the encrypted content data name (the encrypted content name) stated in the request packet, and information about the interface 222 via which the request packet was received to the item 2281, the item 2283, and the item 2284 in an entry in the request storage unit 228 as an original content name, an encrypted content name, and an incoming interface, respectively.

The request processing unit 224 also sends, to the CCN 10 via the interface 222, a new request packet stating the character string indicating the decrypted plaintext content data name (content name). More specifically, the request processing unit 224 sends a request packet stating the plaintext content data name (the content name) to the CCN 10 via the interface 222 selected in accordance with the routing information held by the routing-control-information storage unit 229.

The request processing unit 224 records, as a time stamp, the sending time of the request sent to the CCN 10 to the item 2282 in the entry that matches the plaintext content data name (the content name) held by the request storage unit 228. Also, the request processing unit 224 refers to the item 2282 (the time stamp) in the entry held by the request storage unit 228, and when a predetermined time passes from the previous request sending time or when a data packet corresponding to the request packet is not received for a predetermined time after the previous request sending time, the request processing unit 224 may update the item 2282 (the time stamp) by re-sending the request packet stating the item 2281 (the original content name) in the entry.

The request packet sent from the relay apparatus 22 to the CCN 10 is transferred in the CCN 10 in accordance with the routing-control information held by the relay apparatuses (the relay apparatuses 22 and 12). When the content providing apparatus 13 or another relay apparatus in which a data packet corresponding to the request packet is cached (stored) in the data storage unit 226 receives the request packet, it sends, to the relay apparatus 22, content data (a data packet) corresponding to the plaintext content data name (the content name) included in the request packet.

The data processing unit 223 has the functions of the data receiving unit 136, the data converting unit 137, and the data sending unit 138 in the gateway apparatus 14 in the first embodiment. That is, the data processing unit 223 receives a data packet including content data corresponding to a request packet sent by the request processing unit 224. The data processing unit 223 converts the received data packet by including, in the received data packet as a content data name (an encrypted content data name), the character string including the second character string and the first character string. The data processing unit 223 also sends the data packet, obtained by converting the content data name (the encrypted content data name), to the terminal apparatus 11.

More specifically, the data processing unit 223 receives, via the interface 222, the data packet stating the plaintext content data name (the content name) included in the request packet sent by the request processing unit 224.

The data processing unit 223 also refers to the item 2281 (the original content name) in the entry held by the request storage unit 228. On the basis of the item 2283 (the encrypted content name) and the item 2284 (the incoming interface) in the entry corresponding to the plaintext content data name (the content name) included in each received data packet, the data processing unit 223 obtains the character string in which the first character string is added to the end of the second character string and information about one or more interfaces 222 via which the request packets stating the character string were received. The data processing unit 223 then converts the data packet stating the plaintext content data name (the content name) into a data packet stating the character string in which the first character string is added to the end of the second character string. In this case, the character string stated in the item 2283 (the encrypted content name) in the entry is used as the character string in which the first character string is added to the end of the second character string. The data processing unit 223 sends the converted data packet to the terminal apparatus 11 via one or more interfaces 222 stated in the item 2284 (the incoming interface) in the entry.

The data packet sent from the relay apparatus 22 to the CCN 10 is transferred to the terminal apparatus 11 on the basis of the name stated in the data packet and in accordance with the request storage unit (PIT) held by the relay apparatus 22.

When a plurality of character strings in which the first character string is added to the end of the second character string corresponding to the plaintext content data name (the content name) included in the data packet received by the data processing unit 223 exist, the data processing unit 223 converts the received data packet into data packets stating the respective character strings. For example, when a plurality of items 2283 (encrypted content names) and the items 2284 (the incoming interfaces) paired with the items 2283 (the encrypted content names) exist in association with the item 2281 (the original content name 1101) in an entry, the data processing unit 223 generates a plurality of data packets corresponding to the items 2283 (the encrypted content names) and sends the data packets to the terminal apparatus(es) 11 via one or more interfaces 222 stated in the items 2284 (the incoming interfaces) paired with the items 2283 (the encrypted content names).

The data processing unit 223 then erases, from the request storage unit 228, all entries in which the item 2281 (the original content name) that matches the sent plaintext content data name (content name) is stored.

Also, the data processing unit 223 causes a data packet having the received plaintext content data name to be stored in the data storage unit 226.

The data processing unit 223 may also obtain the predetermined encryption key from the encryption-key/decryption-key management unit 227 and may use the encryption key to encrypt the content data included in a data packet to be sent to the terminal apparatus 11. This can further enhance the confidentiality of communication between the terminal apparatus 11 and the relay apparatus 22. It is, however, assumed that the encryption key is associated in some way with the name indicating the gateway apparatus 14 and the terminal apparatus 11.

When a data packet stating a plaintext content data name (a content name) corresponding to the received request packet exists in the data storage unit 226, the request processing unit 224 does not necessarily have to send the request packet stating the plaintext content data name (the content name). In this case, the data processing unit 223 may immediately send, to the terminal apparatus 11, a data packet stating the character string in which the first character string is added to the end of the second character string.

More specifically, when a data packet stating a plaintext content data name (a content name) corresponding to the received request packet exists in the data storage unit 226, the request processing unit 224 does not cause information in the received request to be stored in the request storage unit 228 and notifies the data processing unit 223 of the character string that is included in the received request packet and in which the first character string is added to the end of the second character string, the plaintext content data name (the content name) obtained by decrypting the first character string, and information about the interface via which the request packet was received. The data processing unit 223 generates a data packet corresponding to the character string in which the first character string is added to the end of the second character string, in accordance with the information received from the request processing unit 224 and on the basis of the data packet corresponding to the plaintext content data name (the content name) stored in the data storage unit 226. The data packet corresponding to the character string in which the first character string is added to the end of the second character string is sent from the data processing unit 223 to the terminal apparatus 11 via the interface 222 via which the request packet was received. Thus, when the plurality of terminal apparatuses 11 attempt to obtain content data stating the same content data name (content name), the relay apparatus 22 can reduce the number of request packets to be sent and can quickly send the data packet to the terminal apparatuses 11.

When the plaintext content data name (the content name) is obtained before the request processing unit 224 converts the received request packet into a request packet stating the plaintext content data name (the content name), there is a case in which the request storage unit 228 has already held an entry in which the plaintext content data name (the content name) corresponding to the received request packet is stored in, for example, the item 2281 (the original content name) illustrated in FIG. 12. In this case, the request processing unit 224 determines that the request packet stating the plaintext content data name (the content name) has already been sent and the relay apparatus 22 is waiting for receiving a data packet stating the plaintext content data name (the content name), and thus the request processing unit 224 does not need to convert the received request packet into a request packet stating the plaintext content data name (the content name). That is, the request processing unit 224 may wait for receiving a data packet stating the plaintext content data name (the content name), without newly sending the request packet stating the plaintext content data name (the content name). With this arrangement, even when a plurality of terminal apparatuses 11 send request packets at substantially the same time in order to obtain content data stating the same plaintext content data name (content name), it is possible to reduce the number of request packets to be sent by the relay apparatus 22. That is, it is possible to reduce traffic in the CCN 10.

As described above, the terminal apparatus 11 receives the data packet in which the character string in which the first character string is added to the end of the second character string is stated as a content data name (an encrypted content data name), thereby making it possible to obtain content data corresponding to the plaintext content data name (the content name).

### Advantages of Second Embodiment, Etc

As described above, according to the present embodiment, it is possible to realize a relay apparatus and a communication method that can use a request packet considering the confidentiality of communication.

More specifically, according to the present embodiment, communication between the relay apparatus 22 having the functions of the gateway apparatus 14 and the terminal apparatus 11 is performed using a request packet in which the plaintext name of content data that the terminal apparatus 11 wishes to obtain is (concealed) encrypted. As a result, only the relay apparatus 22 having the functions of the gateway apparatus 14 can determine which terminal apparatus 11 sent a request for which content data, thus making it possible to ensure the confidentiality of communication for the terminal apparatuses 11.

According to the present embodiment, communication between the relay apparatus 22 having the functions of the gateway apparatus 14 and the terminal apparatus 11 is performed using a data packet in which the plaintext name of content data that the terminal apparatus 11 wishes to obtain is concealed (encrypted). As a result, only the relay apparatus 22 having the functions of the gateway apparatus 14 can determine which terminal apparatus 11 obtained which content data, thus making it possible to ensure the confidentiality of communication for the terminal apparatuses 11.

In addition, according to the present embodiment, since the public key and the secret key in the public-key cryptosystem are used in communication between the relay apparatus 22 having the functions of the gateway apparatus 14 and the terminal apparatuses 11, encryption results (encrypted content names) for the same plaintext content data name (content name) become the same in the terminal apparatuses 11 that use the same public key. Thus, when the names (gateway prefixes) indicating the gateway apparatus 14 are the same, the name used by the relay apparatus 22 having the functions of the gateway apparatus 14 and the names used by the terminal apparatuses 11 become the same for the same content data. This makes it possible to ensure the confidentiality of communication while maintaining efficient data delivery performed by the request storage unit and the data storage unit in the relay apparatus, the efficient data delivery being a feature of the CCN.

### Third Embodiment

Although an example of a case in which one gateway apparatus is used to enhance the confidentiality of communication has been described in the first embodiment, the present disclosure is not limited thereto. A plurality of gateway apparatuses may also be utilized in multiple stages. Such a case will be described in a third embodiment.

### [Configuration of Content Delivery System]

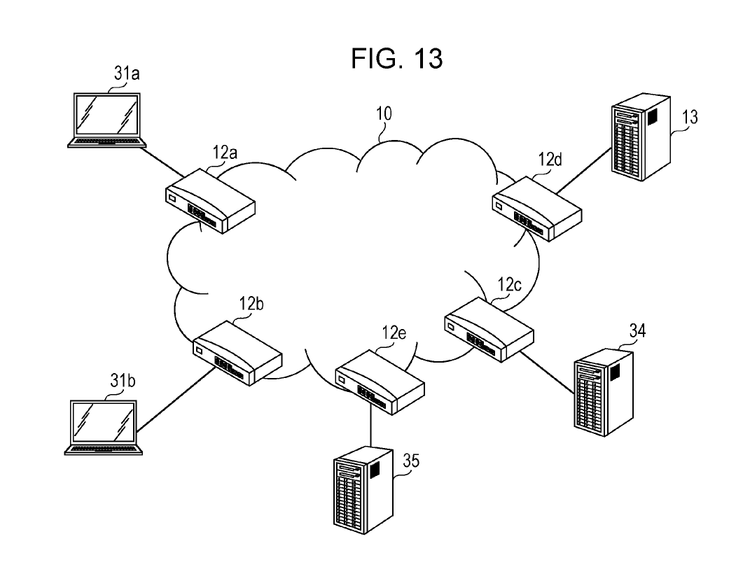

FIG. 13 is a diagram illustrating one example of the configuration of a content delivery system in the third embodiment.

The content delivery system illustrated in FIG. 13 includes relay apparatuses 12 (relay apparatuses 12a to 12e), a content providing apparatus 13, a plurality of terminal apparatuses 31 (terminal apparatuses 31a and 31b), a first gateway apparatus 34, and a second gateway apparatus 35, which are connected to a CCN 10.

### [Configuration of Terminal Apparatus]

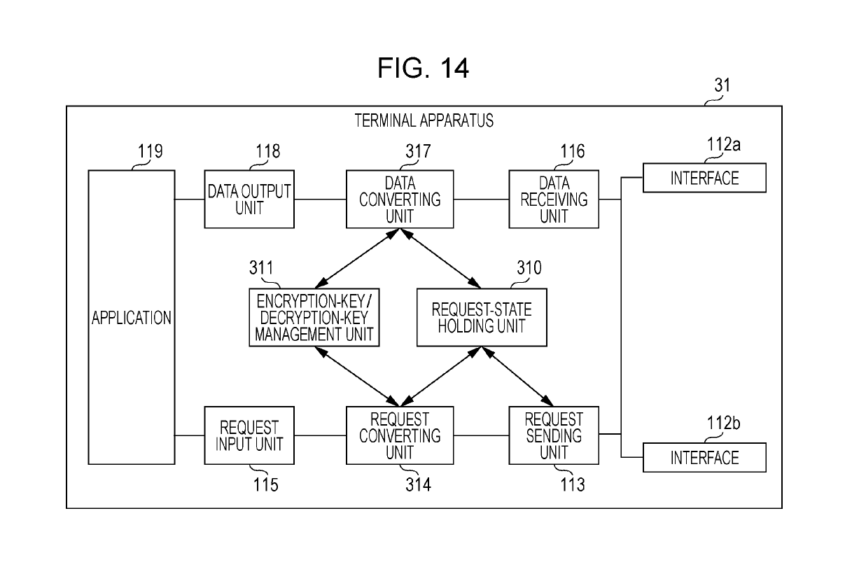

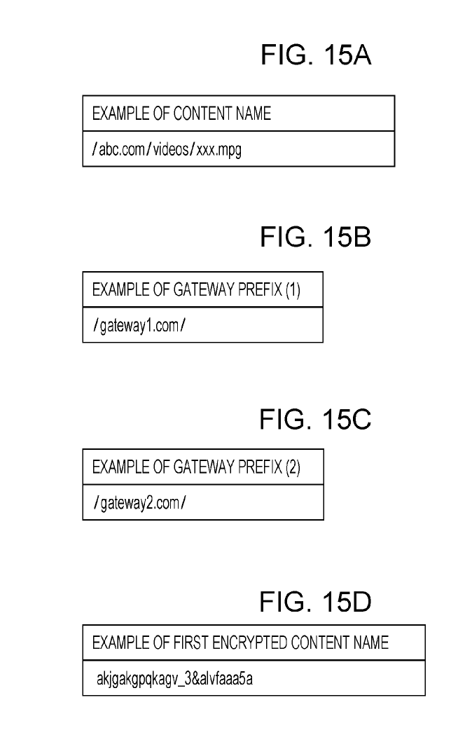

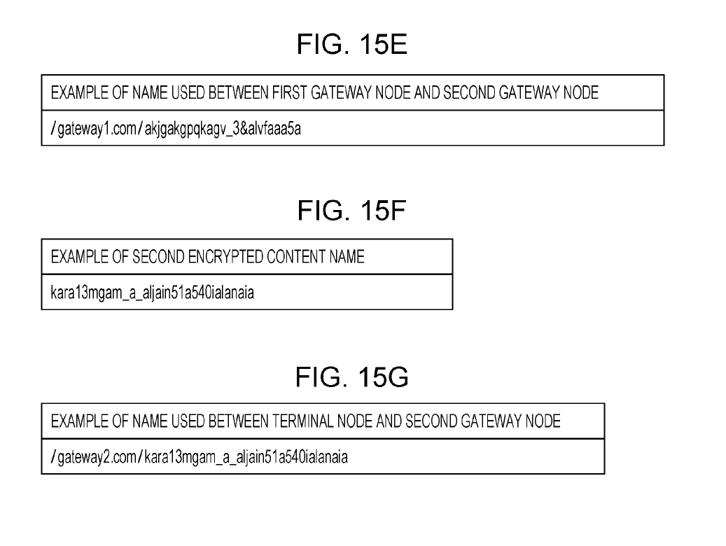

FIG. 14 is a block diagram illustrating one example of a detailed configuration of one terminal apparatus in the third embodiment. FIGS. 15A to 15G illustrate one example of names including the name of content data used by one terminal apparatus in the third embodiment. Elements that are the same as or similar to those in FIG. 1 are denoted by the same reference numerals, and detailed descriptions thereof are not given hereinafter.

The terminal apparatus 31 illustrated in FIG. 14 differs from, for example, the terminal apparatus 11 according to the first embodiment illustrated in FIG. 2 in the configurations of a request-state holding unit 310, an encryption-key/decryption-key management unit 311, a request converting unit 314, and a data converting unit 317. Differences from the first embodiment will be mainly described below.

The request-state holding unit 310 holds a request state. More specifically, the request-state holding unit 310 has an entry including a plurality of items, as illustrated in FIG. 3.

The encryption-key/decryption-key management unit 311 manages encryption keys and a decryption key. The encryption keys are associated with predetermined gateway apparatuses. In the present embodiment, the encryption-key/decryption-key management unit 311 manages an encryption key (a first encryption key) associated with the first gateway apparatus 34 and an encryption key (a second encryption key) associated with the second gateway apparatus 35. For example, the first encryption key is a public key of a secret key and the public key in a public-key cryptosystem, the secret key and the public key being issued by the first gateway apparatus 34. The first gateway apparatus 34 periodically updates the predetermined encryption key. Similarly, the second encryption key is a public key of a secret key and the public key in the public-key cryptosystem, the secret key and the public key being issued by the second gateway apparatus 35. The second gateway apparatus 35 periodically updates the predetermined encryption key.

In the present embodiment, the request converting unit 314 converts a plaintext content data name into a first character string encrypted with the predetermined encryption key (the first encryption key) and generates a request packet in which a character string including a second character string indicating the name of the first gateway apparatus 34 and the first character string is stated as a content data name (an encrypted content data name). The request converting unit 314 further converts the character string including the second character string and the first character string into a third character string encrypted with the encryption key (the second encryption key) different from the predetermined encryption key and generates a request packet in which a character string in which the third character string is added to the end of a fourth character string indicating the name of the second gateway apparatus 35 different from the first gateway apparatus 34 is stated as a content data name (an encrypted content data name).

More specifically, the request converting unit 314 retrieves the corresponding encryption keys associated with the corresponding first gateway apparatus 34 and the second gateway apparatus 35 from the encryption-key/decryption-key management unit 311, encrypts a plaintext content data name (a content name) by using the encryption key (the first encryption key) for the first gateway apparatus 34, and generates a first character string (a first encrypted content name) indicating the encrypted content data name. In addition, the request converting unit 314 generates a character string in which the first character string (the first encrypted content name) is added to the end of the second character string (gateway prefix (1)) indicating the name of the first gateway apparatus 34. In addition, by using the encryption key (the second encryption key) for the second gateway apparatus 35, the request converting unit 314 generates a third character string (a second encrypted content name) obtained by encrypting the character string in which the first character string is added to the end of the second character string. The request converting unit 314 writes, as a content data name (an encrypted content data name) included in the request packet, a character string in which the third character string (the second encrypted content name) is added to the end of the fourth character string (gateway prefix (2)) indicating the name of the second gateway apparatus 35. The request converting unit 314 then records the plaintext content data name (the content name) and the character string in which the third character string is stated at the end of the fourth character string to the item 1101 (the original content name) and the item 1102 (the requested content name), respectively, in an entry in the request-state holding unit 310.

In the present embodiment, by using the first encryption key, the request converting unit 314 converts, for example, “/abc.com/videos/xxx.mpg”, which is a character string of the plaintext content data name (the content name) illustrated in FIG. 15A, to generate, for example, “akjgakgpqkagv_{—}3&alvfaaa5a” illustrated in FIG. 15D as the first character string indicating the encrypted content data name (the first encrypted content name). Next, the request converting unit 314 generates, for example, “/gateway1.com/akjgakgpqkagv_{—}3&alvfaaa5a” (illustrated in FIG. 15E) in which the first character string is added to the end of, for example, “/gateway1.com/” (illustrated in FIG. 15B), which is the second character string (gateway prefix (1)) indicating the name of the first gateway apparatus 34. In addition, the request converting unit 314 uses the second encryption key to encrypt, for example, the character string “/gateway1.com/akjgakgpqkagv_{—}3&alvfaaa5a” in which the first character string is added to the end of the second character string illustrated in FIG. 15E, to generate, for example, “kara13mgam_a_aljain5la540ialanaia” (illustrated in FIG. 15F) which is a third character string (a second encrypted content name). Next, the request converting unit 314 generates, for example, a character string “/gateway2.com/kara13mgam_a_aljain5la540ialanaia” (illustrated in FIG. 15G) in which the third character string is added to the end of, for example, “/gateway2.com/” (illustrated in FIG. 15C) as the fourth character string (gateway prefix (2)) indicating the name of the second gateway apparatus 35.

The request packet sent from the terminal apparatus 31 to the CCN 10 is transferred to the second gateway apparatus 35 on the basis of the name of the second gateway apparatus 35, the name being included in the character string that is stated in the request packet and in which the third character string is stated at the end of the fourth character string, and in accordance with the routing-control information held by the relay apparatuses 12 (the relay apparatuses 12a to 12e).

The data receiving unit 116 receives, via the interface 112, a data packet corresponding to the character string in which the third character string is stated at the end of the fourth character string. Since other processes are substantially the same as those described above in the first embodiment, descriptions thereof are not given hereinafter.

The data converting unit 317 refers to the item 1102 (the requested content name) in an entry held by the request-state holding unit 310. On the basis of the item 1101 (the original content name) in the entry including the item 1102 (the requested content name) corresponding to the character string in which the third character string is stated at the end of the fourth character string, the data converting unit 117 converts the data packet received by the data receiving unit 116 into a data packet stating the plaintext content data name indicated by the item 1101 (the original content name). The data converting unit 317 then deletes the entry including the item 1102 (the requested content name) from the request-state holding unit 310.

When the data packet received by the data receiving unit 116 is encrypted, the data converting unit 317 obtains the decryption keys associated with the first gateway apparatus 34 and the second gateway apparatus 35 from the encryption-key/decryption-key management unit 311 and decrypts the data packet. As described above, when the content data received by the data receiving unit 116 is encrypted, the data converting unit 317 can decrypt the content data by using the decryption keys associated with the first gateway apparatus 34 and the second gateway apparatus 35.

### [Configurations of Gateway Apparatuses]

Since the first gateway apparatus 34 is substantially the same as the gateway apparatus 14 in the first embodiment, the second gateway apparatus 35 will be mainly described in the present embodiment.

### [Configuration of Second Gateway Apparatus]

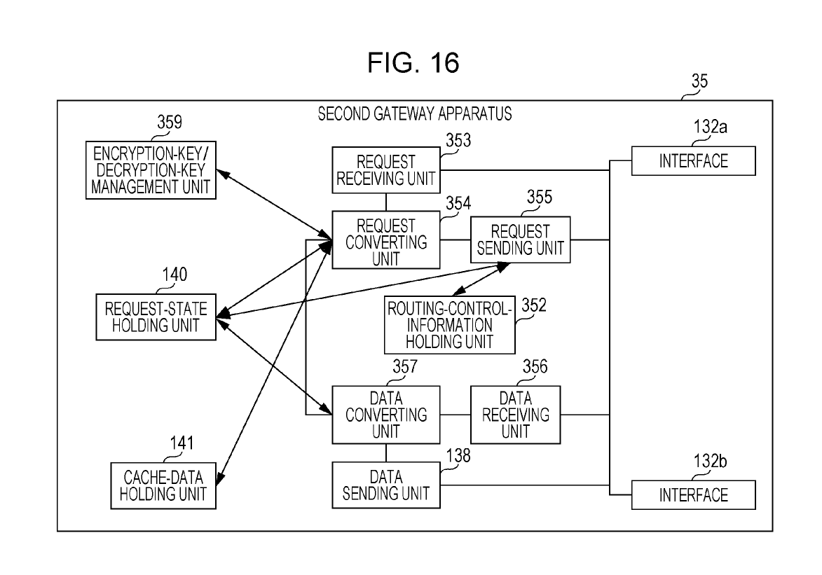

FIG. 16 is a block diagram illustrating one example of a detailed configuration of the second gateway apparatus in the third embodiment. Elements that are the same as or similar to those in FIG. 5 are denoted by the same reference numerals, and detailed descriptions thereof are not given hereinafter.

The second gateway apparatus 35 illustrated in FIG. 16 differs from, for example, the gateway apparatus 14 according to the first embodiment illustrated in FIG. 5 in the configurations of a routing-control-information holding unit 352, a request receiving unit 353, a request converting unit 354, a data receiving unit 356, a data converting unit 357, and an encryption-key/decryption-key management unit 359. Differences from the first embodiment will be mainly described below.

The encryption-key/decryption-key management unit 359 manages a second decryption key and an encryption key (the second encryption key) corresponding to the decryption key. The encryption-key/decryption-key management unit 359 issues the encryption key (the second encryption key) to the terminal apparatus 31 connected to the CCN 10. The encryption-key/decryption-key management unit 359 periodically updates the second encryption key and the second decryption key. In this case, the second encryption key may be a public key of a secret key and the public key in a public-key cryptosystem, the secret key and the public key being issued by the encryption-key/decryption-key management unit 359, and the second decryption key may be the secret key issued by the encryption-key/decryption-key management unit 359.

The request receiving unit 353 receives the request packet including the character string in which the third character string is added, as a content data name (an encrypted content data name), to the end of the fourth character string indicating the name of the second gateway apparatus 35 (local apparatus). In the present embodiment, the request receiving unit 353 receives, via the interface 132, a request packet stating the character string in which the third character string is added to the end of the fourth character string.

The request converting unit 354 converts the request packet received by the request receiving unit 353, by extracting the third character string from the request packet received by the request receiving unit 353, decrypting the extracted third character string with the predetermined second decryption key, and generating a request packet in which the decrypted third character string is included as a content data name.

In the present embodiment, the request converting unit 134 extracts “kara13mgam_a_aljain5la540ialanaia”, which is the third character string (the second encrypted content name), from the character string “/gateway2.com/kara13mgam_a_aljain5la540ialanaia” that is stated in the request packet received by the request receiving unit 353 and in which the third character string is added to the end of the fourth character string. By using the predetermined decryption key retrieved from the encryption-key/decryption-key management unit 359, the request converting unit 354 decrypts the third character string (the second encrypted content name) to obtain the character string “/gateway1.com/akjgakgpqkagv_{—}3&alvfaaa5a” in which the first character string is added to the end of the second character string. The request converting unit 354 then generates a new request packet in which the character string “/gateway1.com/akjgakgpqkagv_{—}3&alvfaaa5a” in which the first character string is added to the end of the second character string is stated as a content data name (an encrypted content data name). In this manner, the request converting unit 354 converts the request packet received by the request receiving unit 353. The above-described decryption key is associated in some way with the name (gateway prefix (2)) of the second gateway apparatus 35 (the local apparatus) and the terminal apparatus 31 that sent the request.

In addition, the request converting unit 354 records the character string “/gateway1.com/akjgakgpqkagv_{—}3&alvfaaa5a” in which the first character string is added to the end of the second character string, the character string “/gateway2.com/kara13mgam_a_aljain5la540ialanaia” that is stated in the request packet and in which the third character string is added to the end of the fourth character string, and information about the interface 132 via which the request packet was received to the item 1401 (the original content name), the item 1403 (the encrypted content name), and the item 1404 (the incoming interface), respectively, in the entry in the request-state holding unit 140.

A request sending unit 355 sends a request packet converted by the request converting unit 354 to the CCN 10. In the present embodiment, the request sending unit 355 sends, to the CCN 10 via the interface 132, a request packet in which the character string “/gateway1.com/akjgakgpqkagv_{—}3&alvfaaa5a” in which the first character string is added to the end of the decrypted second character string is stated as a content data name (an encrypted content data name). Since other processes are the substantially the same as those described above in the first embodiment, descriptions thereof are not given hereinafter.

The request packet sent from the second gateway apparatus 35 to the CCN 10 is transferred to the first gateway apparatus 34 in accordance with the routing-control information held by the relay apparatuses 12.

The data receiving unit 356 receives the data packet including the content data corresponding to the request packet sent by the request sending unit 355. In the present embodiment, the data receiving unit 356 receives, via the interface 132, the data packet in which the character string that is included in the request packet sent by the request sending unit 355 and that includes the second character string and the first character string is stated as a content data name (an encrypted content data name).

The data converting unit 357 converts the data packet received by the data receiving unit 356, by including, in the data packet received by the data receiving unit 356 as a content data name (an encrypted content data name), a character string including the fourth character string and the third character string, instead of the character string including the second character string and the first character string.

More specifically, the data converting unit 357 refers to the item 1401 (the original content name) in the entry held by the request-state holding unit 140. The data converting unit 357 obtains the character string “/gateway2.com/kara13mgam_a_aljain5la540ialanaia” in which the third character string is added to the end of the fourth character string and information about one or more interfaces 132 via which the request packets were received from the item 1403 (the encrypted content name) and the item 1404 (the incoming interface), respectively, in the entry corresponding to the character string “/gateway1.com/akjgakgpqkagv_{—}3&alvfaaa5a” that is included in the data packet received by the data receiving unit 356 and in which the first character string is added to the end of the second character string. Next, the data converting unit 357 converts the data packet stating the character string “/gateway.com/akjgakgpqkagv_{—}3&alvfaaa5a” in which the first character string is added to the end of the second character string into a data packet stating the character string “/gateway2.com/kara13mgam_a_aljain5la540ialanaia” in which the third character string is added to the end of the fourth character string. The data converting unit 357 then deletes, from the request-state holding unit 140, the entry including the item 1401 (the original content name) that matches the character string that is included in the data packet received by the data receiving unit 356 and in which the first character string is added to the end of the second character string. The data packet sent from the second gateway apparatus 35 to the CCN 10 is transferred to the terminal apparatus 11 on the basis of the name stated in the data packet and in accordance with the request storage unit (PIT) held by the relay apparatus 12.

The data converting unit 357 may also store, in the cache-data holding unit 141, the data packet that was received by the data receiving unit 356 and in which the character string including the second character string and the first character string is included as a content data name (an encrypted content data name). The data converting unit 357 may also obtain the predetermined encryption key from the encryption-key/decryption-key management unit 359 and use the encryption key to encrypt the content data included in the data packet to be sent to the terminal apparatus 31. This makes it possible to further enhance the confidentiality of communication between the terminal apparatus 31 and the second gateway apparatus 35. It is, however, assumed that the encryption key is associated in some way with the name indicating the second gateway apparatus 35 and the terminal apparatus 31.

When a data packet in which the character string including the second character string and the first character string is included as a content data name (an encrypted content data name) exists in the cache-data holding unit 141, the request sending unit 355 does not necessarily have to send a request packet in which the character string including the second character string and the first character string is included as a content data name (an encrypted content data name). In this case, the data sending unit 138 may immediately send, to the terminal apparatus 11, a data packet in which the character string including the fourth character string and the third character string is included as a content data name (an encrypted content data name).

More specifically, when a data packet in which the character string including the second character string and the first character string is included as a content data name (an encrypted content data name) exists in the cache-data holding unit 141, the data converting unit 357 refers to the item 1401 (the original content name) in the entry in the request-state holding unit 140. The data converting unit 357 obtains, from the item 1403 (the encrypted content name) and the item 1404 (the incoming interface) in the entry corresponding to the character string including the second character string and the first character string, the character string including the fourth character string and the third character string and information about one or more interfaces 132 via which the request packet stating the character string was received. On the basis of the data packet stored in the cache-data holding unit 141 and corresponding to the character string including the second character string and the first character string, the data converting unit 357 generates a data packet in which the character string stated in the item 1103 (the encrypted content name) in the entry and including the fourth character string and the third character string is included as a content data name (an encrypted content data name). The data packet in which the character string including the fourth character string and the third character string is included as a content data name (an encrypted content data name) is sent from the data sending unit 138 to the terminal apparatus 11 via one or more interfaces 132 stated in the item 1404 (the incoming interface) in the entry. In addition, the data converting unit 357 erases all entries stored in the request-state holding unit 140 and associated with the character string including the second character string and the first character string. With this arrangement, when a plurality of terminal apparatuses 11 attempt to obtain content data stating the same content data name (content name), it is possible to reduce the number of request packets to be sent from the second gateway apparatus 35 and it is possible to quickly send a data packet to the terminal apparatuses 11.

Processing that is the same as or similar to that in the first embodiment may also be performed in order to reduce the amount of memory of the request-state holding unit 140. Since this processing is substantially the same as that described above, a description thereof is not given hereinafter.

When the character string including the second character string and the first character string is obtained before the request converting unit 354 converts the request packet received by the request receiving unit 353 into a request packet in which the character string including the second character string and the first character string is included as a content data name (an encrypted content data name), there are cases in which the request-state holding unit 140 already holds an entry in which the character string including the second character string and the first character string is already stored in, for example, the item 1401 (the original content name) illustrated in FIG. 6. In this case, the request converting unit 354 determines that a request packet in which the character string including the second character string and the first character string is included as a content data name (an encrypted content data name) has already been sent and the second gateway apparatus 35 is waiting for receiving a data packet in which the character string including the second character string and the first character string is included as a content data name (an encrypted content data name), and thus the request converting unit 354 does not need to convert the request packet received by the request receiving unit 353 into a request packet in which the character string including the second character string and the first character string is included as a content data name (an encrypted content data name). That is, the request converting unit 354 does not necessarily have to newly send a request packet in which the character string including the second character string and the first character string is included as a content data name (an encrypted content data name), and the data receiving unit 136 may receive the data packet in which the character string including the second character string and the first character string is included as a content data name (an encrypted content data name). With this arrangement, even when a plurality of terminal apparatuses 11 send request packets at substantially the same time in order to obtain content data stating the same plaintext content data name (content name), it is possible to reduce the number of request packets to be sent from the second gateway apparatus 35.

### [Configuration of First Gateway Apparatus]

The first gateway apparatus 34 corresponds to the gateway apparatus 14 described above in the first embodiment. That is, the request receiving unit 133 receives a request packet in which the character string including the second character string indicating the name of the first gateway apparatus 34 (local apparatus) and the first character string is included as a content data name (an encrypted content data name). In the present embodiment, the request receiving unit 133 receives, via the interface 132, a request packet in which the character string including the second character string and the first character string is included as a content data name (an encrypted content data name). The request converting unit 134 converts the request packet received by the request receiving unit 133, by extracting the first character string from the request packet received by the request receiving unit 133, decrypting the extracted first character string with the predetermined decryption key, and generating a request packet in which the decrypted first character string is included as a content data name (an encrypted content data name). The request sending unit 135 sends the request packet converted by the request converting unit 134 to the CCN 10. The data receiving unit 136 receives the data packet including the content data corresponding to the request packet sent by the request sending unit 135. The data sending unit 138 sends the data packet in which the character string including the second character string and the first character string is included as a name, the data packet being converted by the data converting unit 137, to the second gateway apparatus 35 that sent the request packet received by the request receiving unit 133.

Since detailed processes of the individual constituent elements are substantially the same as those described above in the first embodiment, descriptions thereof are not given hereinafter.

The request packet sent from the first gateway apparatus 34 to the CCN 10 is transferred in the CCN 10 in accordance with the routing-control information held by the relay apparatuses 12. When the content providing apparatus 13 or the relay apparatus 12 in which a data packet corresponding to the request packet is cached (stored) receives the request packet, it sends, to the first gateway apparatus 34, content data (the data packet) corresponding to the plaintext content data name (the content name) included in the received request packet.

Also, the data packet sent from the first gateway apparatus 34 to the CCN 10 is transferred to the second gateway apparatus 35 on the basis of the name stated in the data packet and in accordance with the request storage units (PIT) held by the relay apparatuses 12.

### [Operation of Terminal Apparatus]

Next, a description will be given of an operation of the terminal apparatus 31 configured as described above.

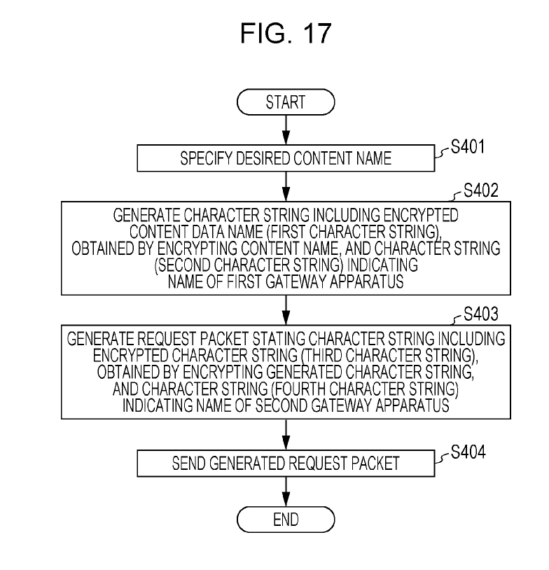

FIG. 17 is a flowchart illustrating the operation of one terminal apparatus in the third embodiment. FIG. 17 illustrates an operation until a request packet is sent, the operation being a characteristic operation of the terminal apparatus 31.

First, the user or an application specifies a desired content name. In the present embodiment, the application 119 inputs a desired plaintext content data name to the request input unit 115 in the terminal apparatus 31 (S401).

Next, the terminal apparatus 31 (the request converting unit 354) encrypts the plaintext content data name with the first encryption key and generates a character string including the encrypted content name (the first character string) and a character string (the second character string) indicating the name of the first gateway apparatus 34 (S402).

In addition, the terminal apparatus 31 (the request converting unit 354) generates a request packet in which a character string in which an encrypted character string (the third character string) obtained by encrypting the generated character string (the character string including the first character string and the second character string) with the second encryption key is added to the end of a character string (the fourth character string) indicating the name of the second gateway apparatus 35 is stated as a content data name (an encrypted content data name) (S403).

Next, the terminal apparatus 31 (the request sending unit 113) sends the generated request packet to the CCN 10 (S403).

As described above, the terminal apparatus 31 can generate a request packet considering the confidentiality of communication.

### [Operation of Second Gateway Apparatus]

Next, a description will be given of the operation of the second gateway apparatus 35 configured as described above.

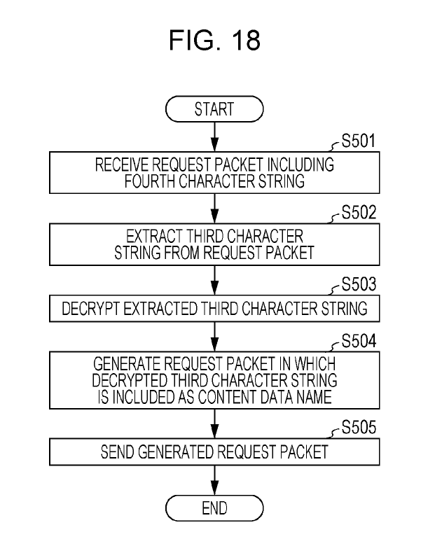

FIG. 18 is a flowchart illustrating the operation of the second gateway apparatus in the third embodiment. FIG. 18 illustrates an operation from when a request packet is received until it is sent, the operation being a characteristic operation of the second gateway apparatus 35.

First, the second gateway apparatus 35 receives a request packet including the fourth character string indicating the name of the local apparatus (S501). In the present embodiment, the second gateway apparatus 35 (the request receiving unit 353) receives a request packet in which a character string in which the third character string is added to the end of the fourth character string indicating the name of the second gateway apparatus 35 (the local apparatus) is included as a content data name (an encrypted content data name).

Next, the second gateway apparatus 35 extracts the third character string from the request packet received in S501 (S502), decrypts the extracted third character string with the predetermined decryption key (S503), and generates a request packet in which the decrypted third character string is included as a content data name (an encrypted content data name) (S504).

Next, the second gateway apparatus 35 sends the request packet generated in S504 to the CCN 10.

Since a subsequent operation of the first gateway apparatus 34 is substantially the same as that described above in the first embodiment, a description thereof is not given hereinafter.

### Advantages of Third Embodiment, Etc

As described above, according to the present embodiment, it is possible to realize a terminal apparatus, and a gateway apparatus that can use a request packet considering the confidentiality of communication and a communication method for the apparatuses.

More specifically, according to the present embodiment, a request packet in which the plaintext name of content data that the terminal apparatus wishes to obtain is encrypted is exchanged between a terminal apparatus and a plurality of gateway apparatuses. As a result, only the gateway apparatuses can determine which terminal apparatus sent a request for which content data, thus making it possible to ensure the confidentiality of communication for the terminal apparatus.

In addition, according to the present embodiment, passing through the plurality of gateway apparatuses in multiple stages makes it possible to enhance the confidentiality of communication. Also, according to the present embodiment, contriving the method for generating a name to be stated in a request packet sent by the terminal apparatus offers an advantage in that the confidentiality of communication can be easily enhanced without special coordination between the gateway apparatuses.

In addition, according to the present embodiment, a public key and a secret key in the public-key cryptosystem are used for each of the encryption that each terminal apparatus 31 performs on a plaintext content data name (a content name), the decryption that the first gateway apparatus 34 performs on the first character string (the first encrypted content name), which is the encrypted content data name, and the decryption that the second gateway apparatus 35 performs on the third character string (the second encrypted content name) obtained by encrypting the character string in which the first character string is added to the end of the second character string. As a result, in the plurality of terminal apparatuses 31 that use the same public key, results (the first encrypted content names) of the encryption of the same plaintext content data name (content name) become the same, and results (the second encrypted content names) of the encryption of the character string in which the first character string is added to the end of the second character string become the same. As a result, when the names (gateway prefix (1)) indicating the first gateway apparatus 34 are the same, the character strings that are used between the first gateway apparatus 34 and the second gateway apparatus 35 and in which the first character string is added to the end of the second character string become the same for the same content data, and when the names (gateway prefix (2)) indicating the second gateway apparatus 35 are the same, the character strings that are used between the plurality of terminal apparatuses 31 and the second gateway apparatus 35 and in which the third character string is stated at the end of the fourth character string become the same for the same content data. Thus, it is possible to ensure the confidentiality of communication while maintaining efficient data delivery performed by the request storage unit and the data storage unit in the relay apparatus, the efficient data delivery being a feature of the CCN.

Although the terminal apparatus, the gateway apparatus, and the relay apparatus according to one or more aspects have been described above on the basis of the embodiments, the present disclosure is not limited to the embodiments. Modes obtained by applying various modifications conceived by those skilled in the art to the embodiments or modes constituted by combining constituent elements in different embodiments may also be encompassed by the scope of one or more aspects of the present disclosure, as long as such modes do not depart from the spirit of the present disclosure.

For example, although the above-description has been given of a case in which the character string in which the third character string is added to the end of the fourth character string is used between the terminal apparatuses 31 and the second gateway apparatus 35, the present disclosure is not limited thereto. It is sufficient as long as a character string including the fourth character string and the third character string is stated. In addition, although the above-description has been given of a case in which the character string in which the first character string is added to the end of the second character string is used between the first gateway apparatus 34 and the second gateway apparatus 35, the present disclosure is not limited thereto. It is sufficient as long as a character string including the second character string and the first character string is stated.

Additionally, although gateway prefix (1) has been described above as an example of the character indicating the name of the first gateway apparatus 34, the present disclosure is not limited thereto. The character may also be part of the name indicating the first gateway apparatus 34 or a character string associated with the first gateway apparatus 34, as long as a request packet arrives at the first gateway apparatus 34 when the character is stated in the request packet. Similarly, although gateway prefix (2) has been described above as an example of the character indicating the name of the second gateway apparatus 35, the present disclosure is not limited thereto. The character may also be part of the name indicating the second gateway apparatus 35 or a character string associated with the second gateway apparatus 35, as long as a request packet arrives at the second gateway apparatus 35 when the character is stated in the request packet.

For example, the present disclosure also encompasses cases as described below.

(1) Each of the above-described terminal apparatus, gateway apparatus, and relay apparatus (each of which is hereinafter referred to collectively as an “apparatus”) is, specifically, a computer system including a microprocessor, a read-only memory (ROM), a random-access memory (RAM), a hard disk unit, a display unit, a keyboard, a mouse, and so on. The RAM or the hard disk unit stores therein a computer program. The microprocessor operates in accordance with the computer program, so that each apparatus realizes its functions. In order to realize predetermined functions, the computer program is constituted by a combination of command codes indicating instructions for a computer.

(2) Some or all of the constituent elements included in each of the apparatuses may be implemented by a single system large-scale integrated (LSI) circuit. The system LSI is a super-multifunctional LSI manufactured by integrating constituent elements on one chip and is, specifically, a computer system including a microprocessor, a ROM, a RAM, and so on. The computer program is stored in the RAM. The microprocessor operates in accordance with the computer program, so that the system LSI realizes its functions.

(3) Some or all of the constituent elements included in each of the apparatuses described above may be implemented by an integrated circuit (IC) card that can be inserted into and removed from the apparatus or an individual module. The IC card or the module is a computer system including a microprocessor, a ROM, a RAM, and so on. The IC card or the module may include the aforementioned super-multifunctional LSI. The microprocessor operates in accordance with the computer program, so that the IC card or the module realizes its functions. The IC card or the module may be tamper-proof.

(4) The present disclosure may also be implemented by the methods described above. Those methods may also be realized by a computer program implemented by a computer or may be realized using digital signals provided by the computer program.

In the present disclosure, the computer program or the digital signals may be recorded on computer-readable recording media, for example, a flexible disk, a hard disk, a CD-ROM, a magneto-optical (MO) disk, a digital versatile disk (DVD), a DVD-ROM, a DVD-RAM, a Blu-ray Disc (BD), and a semiconductor memory. The present disclosure may also be realized by the digital signals recorded on the recording media.

Additionally, in the present disclosure, the computer program or the digital signals may be transmitted over a telecommunication channel, a wireless or wired communication channel, a network typified by the Internet, data broadcasting, or the like.

Moreover, the present disclosure may be realized by a computer system including a microprocessor and a memory, the memory may pre-store the computer program, and the microprocessor may operate in accordance with the computer program.

The present disclosure may also be implemented by another independent computer system by transporting the recording medium on which the program or the digital signals are recorded or transferring the program or the digital signals via the network or the like.

(5) The above-described embodiments and the modifications may also be combined together.

The present disclosure can be applied to a terminal apparatus, a gateway apparatus, a relay apparatus, and so on, and can be particularly applied to a terminal apparatus, a gateway apparatus, a relay apparatus, and so on connected to a content-centric network.

What is claimed is:

1. A terminal apparatus connected to a content-centric network, the terminal apparatus comprising:
a processor; and
a non-transitory memory having stored therein instructions which, when executed by the processor, cause the processor to perform operations comprising:
encrypting a name of content data with a predetermined encryption key to convert the content data name into a first character string,
generating a request packet in which a character string is stated as the content data name, the character string including a second character string indicating a name of a gateway apparatus and the first character string, and;
sending the generated request packet to the network.

2. The terminal apparatus according to claim 1,
wherein the operations further comprise:
receiving, as a data packet of the content data, a data packet in which a character string including the second character string and the first character string is stated as a name.

3. The terminal apparatus according to claim 2,
wherein the received data packet is encrypted; and
wherein the operations further comprise decrypting the received data packet.

4. The terminal apparatus according to claim 1,
wherein the predetermined encryption key is a public key of a secret key and the public key in a public-key cryptosystem, the secret key and the public key being issued by the gateway apparatus.

5. The terminal apparatus according to claim 4,
wherein the gateway apparatus periodically updates the predetermined encryption key.

6. The terminal apparatus according to claim 1,
wherein, in the generating of the request packet, the character string including the second character string and the first character string is further converted into a third character string encrypted with an encryption key different from the predetermined encryption key, and a request packet in which a character string including a fourth character string indicating a name of another gateway apparatus different from that gateway apparatus and the third character string is stated as the content data name is generated.

7. A gateway apparatus connected to a content-centric network, the gateway apparatus comprising:
a processor; and
a non-transitory memory having stored therein instructions which, when executed by the processor, cause the processor to perform operations comprising:
receiving, as a name of content data, a request packet including a character string including a second character string indicating a name of the gateway apparatus and an encrypted first character string;
converting the received request packet by extracting the encrypted first character string from the received request packet, decrypting the extracted encrypted first character string with a predetermined decryption key, and generating a request packet in which the decrypted first character string is included as the content data name; and
sending the converted request packet to the network.

8. The gateway apparatus according to claim 7,
wherein the operations further comprise:
receiving a data packet including the content data corresponding to the converted request packet;
converting the received data packet by including, in the received data packet as the content data name, a character string including the second character string and the first character string; and
sending the converted data packet to a terminal apparatus that sent the received request packet.

9. The gateway apparatus according to claim 8,
wherein the operations further comprise:
holding a sending time of the sent request packet,
wherein, in the sending of the converted request packet, when a data packet including the content data corresponding to the sent request packet is not received for a predetermined time after the sending time, the request packet is re-sent.

10. The gateway apparatus according to claim 8,
wherein the operations further comprise:
storing a data packet;
wherein, when the data packet in which the decrypted first character string is included as the content data name is stored,
the converted request packet is not sent to the network, and
the stored data packet is sent to the terminal apparatus as a data packet stating a character string including the second character string and the first character string.

11. The gateway apparatus according to claim 7,
wherein the operations further comprise:
managing the predetermined decryption key and an encryption key corresponding to the predetermined decryption key,
wherein the encryption key is issued to a terminal apparatus connected to the network,
the encryption key is a public key of a secret key and a public key in a public-key cryptosystem, the secret key and the public key being issued to the terminal apparatus, and
the predetermined decryption key is the secret key issued to the terminal apparatus.

12. The gateway apparatus according to claim 11,
wherein, in the managing of the secret key, the encryption key and the predetermined decryption key are periodically updated.

13. A relay apparatus connected to a content-centric network to relay a request packet and a data packet, the relay apparatus comprising:
a processor; and
a non-transitory memory having stored therein instructions which, when executed by the processor, cause the processor to perform operations comprising:
receiving a request packet including a character string in which a second character string indicating a name of the relay apparatus and a first character string is included as a name of content data;
converting the received request packet by extracting the first character string from the received request packet, decrypting the extracted first character string with a predetermined decryption key, and generating a request packet in which the decrypted first character string is included as the content data name; and
sending the converted request packet to the network.

14. The relay apparatus according to claim 13,
wherein the operations further comprise:
receiving a data packet including the content data corresponding to the sent request packet;
converting the received data packet by including, in the received data packet as the content data name, a character string including the second character string and the first character string; and
sending the converted data packet to a terminal apparatus that sent the received request packet.

15. A communication method for a terminal apparatus connected to a content-centric network to send a request packet stating a name of content data and to receive a data packet including the content data, the communication method comprising:
encrypting the content data name with a predetermined encryption key to convert the content data name into a first character string and generating a request packet in which a character string is stated as the content data name, the character string including a second character string indicating a name of a gateway apparatus and the first character string, and;
sending the request packet generated in the generating of the request packet to the network.

16. A communication method for a gateway apparatus connected to a content-centric network, the communication method comprising:
receiving a request packet including a character string in which a second character string indicating a name of the gateway apparatus and a first character string is included as a name of content data;
converting the request packet received in the receiving of the request packet, by extracting the first character string from the received request packet, decrypting the extracted first character string with a predetermined decryption key, and generating a request packet in which the decrypted first character string is included as the content data name; and
sending the request packet converted in the converting of the request packet to the network.

17. A communication method for a relay apparatus connected to a content-centric network to relay a request packet and a data packet, the communication method comprising:
receiving a request packet including a character string in which a second character string indicating a name of the gateway apparatus and a first character string is included as a name of content data;
converting the request packet received in the receiving of the request packet, by extracting the first character string from the received request packet, decrypting the extracted first character string with a predetermined decryption key, and generating a request packet in which the decrypted first character string is included as the content data name; and
sending the request packet converted in the converting of the request packet to the network.
